(19) United States
(12) Patent Application Publication
(10) Pub. No.: US 2026/0173206 A1
(43) Pub. Date: Jun. 18, 2026

(54) METHOD AND APPARATUS FOR DISCONTINUOUS RECEPTION OPERATION CONTROL

(71) Applicant: Electronics and Telecommunications Research Institute, Daejeon (KR)

(72) Inventors: Jisoo PARK, Daejeon (KR); Hoondong NOH, Daejeon (KR); Nam Il KIM, Daejeon (KR)

(21) Appl. No.: 19/383,464

(22) Filed: Nov. 7, 2025

(30) Foreign Application Priority Data
Nov. 8, 2024 (KR) 10-2024-0157597
Nov. 4, 2025 (KR) 10-2025-0164687

(51) Int. Cl. H04W 76/28; H04W 72/02

(52) U.S. Cl. CPC H04W 76/28; H04W 72/02

(57) ABSTRACT

A method of a terminal may comprise: receiving, from a base station, user equipment (UE) discontinuous reception (DRX) beam configuration information through one or more first beams covering a first beam service area in which a terminal group to which the terminal belongs is located; transmitting, to the base station, a beam report for the one or more first beams; and receiving, from the base station, UE DRX beam control information based on the UE DRX beam configuration information.

### CROSS-REFERENCE TO RELATED APPLICATIONS

This application claims priority to Korean Patent Applications No. 10-2024-0157597, filed on Nov. 8, 2024, and No. 10-2025-0164687, filed on Nov. 4, 2025, with the Korean Intellectual Property Office (KIPO), the entire contents of which are hereby incorporated by reference.

### BACKGROUND

### 1. Technical Field

The present disclosure relates to an enhanced communication technique, and more particularly, to a technique for controlling a discontinuous reception (DRX) operation of a terminal.

### 2. Related Art

A communication network (e.g. 5G communication network, 6G communication network, and the like) for providing improved communication services compared to an existing communication network (e.g. long term evolution (LTE), LTE Advanced (LTE-A), and the like) is being developed. The 5G communication network (e.g. new radio (NR) communication network) can support frequency bands of 6 GHz or lower as well as frequency bands above 6 GHz. In other words, the 5G communication network can support frequency range 1 (FR1) and/or frequency range 2 (FR2). The 5G communication network can support various communication services and scenarios compared to the LTE communication network. For example, usage scenarios of the 5G communication network may include enhanced Mobile Broadband (eMBB), Ultra-Reliable Low Latency Communication (URLLC), and massive Machine Type Communication (mMTC).

In order to support advanced next-generation services such as 5G, 5G-Advanced, and 6G, wireless communication technologies include beamforming using advanced smart antenna technologies and massive multiple-input multiple-output (mMIMO) technologies. The advanced wireless communication technologies include various radio frame structures, system transmission specifications of various numerology types, and definitions of uplink/downlink physical channels. In the advanced wireless communication technologies, various reference signals may be defined, and the defined reference signals may be used for various purposes. The defined reference signals may be used for reporting wireless channel states.

In a communication system, various beamforming technologies have been developed as measures for satisfying requirements for high-speed data transmission. Beamforming antenna technology is a technology in which energy of signals transmitted through multiple antennas is concentrated and delivered in a specific direction. Beamforming antenna technology controls power or phase supplied to antennas so as to supply maximum power in a desired direction.

Meanwhile, increases in network capacity to satisfy requirements for high-speed data transmission and expansion of various base stations to which beamforming antenna technology is applied increase power consumption due to transmission of wireless signals. The increases in power consumption require improvements in network energy saving. Therefore, efficient use of network transmission energy is a core requirement of next-generation communication technologies.

As performance indicators for development of communication systems for 5G communication networks and 6G communication networks, development of various energy saving technologies is required in order to reduce network operating costs and reduce environmental impacts. Network energy saving (NES) technologies defined in technical specifications focus on reducing power consumption of network elements, improving network efficiency, and also extending battery lifetime of user equipment (UE).

For NES, cell discontinuous transmission (DTX)/discontinuous reception (DRX) may be proposed. In cell DTX/DRX technologies, a base station and a terminal perform the following operations. In a DTX non-active duration, the base station (e.g. gNB) performs an operation of stopping downlink (DL) transmission. The terminal (e.g. UE) may not perform a reception operation for specific wireless signals. The terminal may not perform uplink (UL) transmission in a DRX non-active duration. The base station does not perform a reception operation for UL wireless signals. Through the cell DTX/DRX technologies, an effect of saving network energy may be achieved.

The base station may stop transmission of control signals through a cell DTX operation, or may turn off a transmitter (e.g. a power amplifier (PA)) of the base station when traffic does not exist. The base station may turn off a receiver (e.g. a radio frequency (RF) chain) through a cell DRX operation when traffic does not exist. The base station may reduce network power consumption through cell DTX/DRX operations.

Even when traffic does not exist between a network (e.g. base station) and a terminal, the terminal is required to continuously receive downlink wireless signals transmitted by the network. The terminal is required to be prepared to decode at least a physical downlink control channel (PDCCH) for delivering downlink control information (DCI) such as scheduling. In other words, even when there is no data to be received, the terminal is required to always remain in an ON state. However, when the terminal remains in the ON state at all times, battery consumption of the terminal occurs. A terminal energy saving technology for reducing battery consumption of the terminal is a UE DRX technology.

A terminal may not perform uplink transmission during a certain time duration through a UE DTX operation. The terminal may not perform a monitoring operation for receiving a PDCCH during a certain time duration through a UE DRX operation. The terminal may reduce power consumption of the terminal through UE DTX/DRX operations.

Even when multiple beams are formed, UE DRX configuration for beams included in a serving cell may be performed. When a beam service area to which a terminal for which UE DRX is configured belongs is not considered in cell DTX configuration and/or UE DRX control, precise UE DRX configuration or control may be impossible. When precise DRX configuration or control is impossible, a problem may occur in which an effect of reducing terminal power consumption due to DRX configuration or control is degraded.

### SUMMARY

The present disclosure for resolving the above-described problems is directed to providing a method and apparatus for UE DRX configuration and control considering a beam service area.

A method of a terminal, according to exemplary embodiments of the present disclosure, may comprise: receiving, from a base station, user equipment (UE) discontinuous reception (DRX) beam configuration information through one or more first beams covering a first beam service area in which a terminal group to which the terminal belongs is located; transmitting, to the base station, a beam report for the one or more first beams; and receiving, from the base station, UE DRX beam control information based on the UE DRX beam configuration information.

The method may further comprise: performing a beam DRX operation for the one or more first beams based on the UE DRX beam configuration information, wherein the beam DRX operation may be performed by activation or deactivation of beam DRX for the one or more first beams based on the UE DRX beam control information.

The method may further comprise: performing a beam DRX operation for one or more second beams based on the UE DRX beam configuration information, based on the UE DRX beam control information being received through the one or more second beams covering a second beam service area adjacent to the first beam service area.

The UE DRX beam configuration information may include at least one of: DRX beam information for configuring beam DRX of a terminal group belonging to a specific beam service area covered by a beam formed by the base station; DRX beam group information for configuring beam DRX of a terminal group belonging to a beam group service area covered by a beam group including a plurality of beams formed by the base station; or cell-common DRX beam information for configuring beam DRX of a terminal group belonging to a cell-common service area covered by a cell formed by the base station.

The DRX beam information may include at least one of: beam information associated with the beam, a DRX beam terminal group temporary identifier corresponding to the beam, or information on a DRX beam service duration for a beam DRX operation associated with the beam, the beam information may include at least one of identification information of the beam, information of a reference signal transmitted through the beam, or a transmission configuration indicator (TCI) state associated with the reference signal, and based on the DRX beam information including the information on the DRX beam service duration, the information on the DRX beam service duration may include at least one of an on-duration, an off-duration, a DRX cycle, or a DRX start offset.

The DRX beam group information may include at least one of: beam information associated with each of the plurality of beams, a DRX beam group temporary identifier corresponding to the beam group, or information on a DRX beam service duration for a beam DRX operation associated with the beam group, the beam information may include at least one of identification information of each of the plurality of beams, information of reference signals transmitted through the plurality of beams, or TCI states associated with the reference signals, and based on the DRX beam group information including the information on the DRX beam service duration, the information on the DRX beam service duration may include at least one of an on-duration, an off-duration, a DRX cycle, or a DRX start offset.

The cell-common DRX beam information may include at least one of: beam information associated with each of beams belonging to the cell; a cell-common DRX beam temporary identifier corresponding to the cell; or information on a DRX beam service duration for a beam DRX operation associated with the beams, the beam information may include at least one of identification information of each of the beams, information of reference signals transmitted through the beams, or TCI states associated with the reference signals, and based on the cell-common DRX beam information including information on the DRX beam service duration, the information on the DRX beam service duration may include at least one of an on-duration, an off-duration, a DRX cycle, or a DRX start offset.

The UE DRX beam control information may include at least one of beam information for each of the one or more first beams, information on a DRX beam service duration for the beam DRX operation, or information indicating activation or deactivation of beam DRX for the one or more first beams.

The receiving of the UE DRX beam control information may comprise: performing a monitoring operation to receive a physical downlink control channel (PDCCH) including downlink control information (DCI) including the UE DRX beam control information, based on a temporary identifier included in the UE DRX beam configuration information; and decoding the PDCCH to check a cyclic redundancy check (CRC) of the DCI scrambled with the temporary identifier, and receiving the UE DRX beam control information from the DCI.

The receiving of the UE DRX beam control information may comprise: performing a monitoring operation to receive a PDCCH including DCI indicating a physical downlink shared channel (PDSCH) including the UE DRX beam control information, based on a temporary identifier included in the UE DRX beam configuration information; decoding the PDCCH and performing decoding of the PDSCH based on a CRC of the DCI scrambled with the temporary identifier; and receiving the UE DRX beam control information based on the decoding.

The method may further comprise: stopping reception of one or more first signals transmitted through the one or more first beams during an off-duration indicated by the information on the DRX beam service duration, based on performing activation of the beam DRX, wherein a type of the one or more first signals may be one of a synchronization signal block, a synchronization signal, a PDCCH, a PDSCH, a channel state information reference signal (CSI-RS), a tracking reference signal (TRS), or a phase tracking reference signal (PT-RS).

A method of a base station, according to exemplary embodiments of the present disclosure, may comprise: transmitting, to a terminal, user equipment (UE) discontinuous reception (DRX) beam configuration information; receiving, from the terminal, a beam report for one or more beams covering a beam service area in which a terminal group to which the terminal belongs is located; determining, based on the beam report, whether to activate beam DRX of the terminal for the one or more beams; and transmitting, to the terminal, UE DRX beam control information based on the determination.

The beam report may include at least one of: channel state information (CSI) generated by the terminal or a measurement report for the one or more beams, and whether to activate beam DRX of the terminal may be determined further based on at least one of a number of terminals belonging to the terminal group, a traffic load of the base station, or an energy state of a network to which the base station belongs.

The UE DRX beam configuration information may include at least one of: DRX beam information for configuring beam DRX of a terminal group belonging to a specific beam service area covered by a beam formed by the base station; DRX beam group information for configuring beam DRX of a terminal group belonging to a beam group service area covered by each of a plurality of beams formed by the base station; or cell-common DRX beam information for configuring beam DRX of a terminal group belonging to a cell-common service area covered by a cell formed by the base station.

The DRX beam information may include at least one of: beam information associated with the beam; a DRX beam terminal group temporary identifier corresponding to the beam; or information on a DRX beam service duration for a beam DRX operation of a terminal associated with the beam, the beam information may include at least one of identification information of the beam, information of a reference signal transmitted through the beam, or a transmission configuration indicator (TCI) state associated with the reference signal, and based on the DRX beam information including the information on the DRX beam service duration, the information on the DRX beam service duration may include at least one of an on-duration, an off-duration, a DRX cycle, or a DRX start offset.

The DRX beam group information may include at least one of: beam information associated with each of the plurality of beams; a DRX beam group temporary identifier corresponding to the plurality of beams; or information on a DRX beam service duration for a DRX operation of a terminal associated with the plurality of beams, the beam information may include at least one of identification information of each of the plurality of beams, information of reference signals transmitted through the plurality of beams, or TCI states associated with the reference signals, and based on the DRX beam group information including the information on the DRX beam service duration, the information on the DRX beam service duration may include at least one of an on-duration, an off-duration, a DRX cycle, or a DRX start offset.

The cell-common DRX beam information may include at least one of: beam information associated with each of beams belonging to the cell; a cell-common DRX beam temporary identifier corresponding to the cell; or information on a DRX beam service duration for a beam DRX operation of a terminal associated with the beams, the beam information may include at least one of identification information of each of the beams, information of reference signals transmitted through the beams, or TCI states associated with the reference signals, and based on the cell-common DRX beam information including the information on the DRX beam service duration, the information on the DRX beam service duration may include at least one of an on-duration, an off-duration, a DRX cycle, or a DRX start offset.

The UE DRX beam control information may include at least one of beam information for each of the one or more beams, information on a DRX beam service duration for a DRX operation by the terminal, or information indicating activation or deactivation of DRX for the one or more beams.

The method may further comprise: performing suspension of downlink transmission to the terminal using the one or more beams during an off-duration indicated by the information on the DRX beam service duration, wherein a signal subject to the suspension of the downlink transmission may include at least one of a synchronization signal block, a synchronization signal, a physical downlink control channel (PDCCH), a physical downlink shared channel (PDSCH), a channel state information reference signal (CSI-RS), a tracking reference signal (TRS), or a phase tracking reference signal (PT-RS).

The UE DRX beam control information may be transmitted through a PDCCH including downlink control information (DCI) having a cyclic redundancy check (CRC) scrambled based on a temporary identifier included in the UE DRX beam configuration information, or may be transmitted through a PDSCH indicated by the DCI.

According to the present disclosure, a base station may generate UE DRX beam configuration information based on beam service areas. The base station may transmit UE DRX beam configuration information to respective terminal groups belonging to different beam service areas. The base station may determine whether to control a DRX operation of a terminal group based on a measurement report transmitted from a terminal. The base station may transmit DRX beam control information to the terminal group based on determining to control the DRX operation of the terminal group. The base station may perform DRX operation control according to beam service areas through the DRX beam control information. Through the above-described procedures, precise DRX control according to beam service areas may be performed. The precise DRX control according to beam service areas may reduce power consumption of terminals.

### BRIEF DESCRIPTION OF DRAWINGS

FIG. 1 is a conceptual diagram illustrating exemplary embodiments of a communication system.

FIG. 2 is a block diagram illustrating exemplary embodiments of a communication node constituting a communication system.

FIG. 3 is a conceptual diagram illustrating exemplary embodiments of terminal groups according to beam service areas.

FIG. 4A is a timing diagram illustrating exemplary embodiments of a DRX beam service duration.

FIG. 4B is a timing diagram illustrating exemplary embodiments of a DRX beam service duration.

FIG. 4C is a timing diagram illustrating exemplary embodiments of a DRX beam service duration.

FIG. 5A is a sequence diagram illustrating exemplary embodiments of a UE DRX operation control procedure.

FIG. 5B is a sequence diagram illustrating exemplary embodiments of a UE DRX operation control procedure.

FIG. 5C is a sequence diagram illustrating exemplary embodiments of a UE DRX operation control procedure.

FIG. 5D is a sequence diagram illustrating exemplary embodiments of a UE DRX operation control procedure.

FIG. 6A is a sequence diagram illustrating exemplary embodiments of a UE DRX operation control procedure.

FIG. 6B is a sequence diagram illustrating exemplary embodiments of a UE DRX operation control procedure.

FIG. 6C is a sequence diagram illustrating exemplary embodiments of a UE DRX operation control procedure.

FIG. 6D is a sequence diagram illustrating exemplary embodiments of a UE DRX operation control procedure.

FIG. 7A is a sequence diagram illustrating exemplary embodiments of a UE DRX operation control procedure.

FIG. 7B is a sequence diagram illustrating exemplary embodiments of a UE DRX operation control procedure.

FIG. 7C is a sequence diagram illustrating exemplary embodiments of a UE DRX operation control procedure.

### DETAILED DESCRIPTION OF THE EMBODIMENTS

Since the present disclosure may be variously modified and have several forms, specific exemplary embodiments will be shown in the accompanying drawings and be described in detail in the detailed description. It should be understood, however, that it is not intended to limit the present disclosure to the specific exemplary embodiments but, on the contrary, the present disclosure is to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named a second component without departing from the scope of the present disclosure, and the second component may also be similarly named the first component. The term “and/or” means any one or a combination of a plurality of related and described items.

In the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

In the present disclosure, ‘(re) transmission’ may refer to ‘transmission’, ‘retransmission’, or ‘transmission and retransmission’, ‘(re) configuration’ may refer to ‘configuration’, ‘reconfiguration’, or ‘configuration and reconfiguration’, ‘(re)connection’ may refer to ‘connection’, ‘reconnection’, or ‘connection and reconnection’, and ‘(re)access’ may refer to ‘access’, ‘re-access’, or ‘access and re-access’.

When it is mentioned that a certain component is “coupled with” or “connected with” another component, it should be understood that the certain component is directly “coupled with” or “connected with” to the other component or a further component may be disposed therebetween. In contrast, when it is mentioned that a certain component is “directly coupled with” or “directly connected with” another component, it will be understood that a further component is not disposed therebetween.

The terms used in the present disclosure are only used to describe specific exemplary embodiments, and are not intended to limit the present disclosure. The singular expression includes the plural expression unless the context clearly dictates otherwise. In the present disclosure, terms such as ‘comprise’ or ‘have’ are intended to designate that a feature, number, step, operation, component, part, or combination thereof described in the specification exists, but it should be understood that the terms do not preclude existence or addition of one or more features, numbers, steps, operations, components, parts, or combinations thereof.

Unless otherwise defined, all terms (including technical and scientific terms) used herein have the same meaning as commonly understood by one of ordinary skill in the art to which this disclosure belongs. Terms that are generally used and have been in dictionaries should be construed as having meanings matched with contextual meanings in the art. In this description, unless defined clearly, terms are not necessarily construed as having formal meanings.

Hereinafter, exemplary embodiments of the present disclosure will be described in detail with reference to the accompanying drawings. In describing the disclosure, to facilitate the entire understanding of the disclosure, like numbers refer to like elements throughout the description of the figures and the repetitive description thereof will be omitted.

A communication network (or communication system) to which exemplary embodiments according to the present disclosure are applied will be described. The communication network to which exemplary embodiments according to the present disclosure are applied is not limited to the content described below, and the exemplary embodiments according to the present disclosure can be applied to various communication networks. Here, the term ‘communication network’ may be used interchangeably with ‘communication system’. The communication network may refer to a wireless communication network, and the communication system may refer to a wireless communication system.

In the present disclosure, ‘configuration of an operation (e.g. transmission operation)’ may refer to signaling of configuration information (e.g. information elements, parameters) required for the operation and/or information indicating to perform the operation. ‘configuration of information elements (e.g. parameters)’ may refer to signaling of the information elements. In the present disclosure, signaling may be at least one of System Information (SI) signaling (e.g. transmission of System Information Block (SIB) and/or Master Information Block (MIB)), RRC signaling (e.g. transmission of RRC parameters and/or higher-layer parameters), MAC Control Element (CE) signaling, or PHY signaling (e.g. transmission of Downlink Control Information (DCI), Uplink Control Information (UCI), and/or Sidelink Control Information (SCI).

The names of frames proposed in the present disclosure may be generalized as a first frame, a second frame, a third frame, and the like. In the present disclosure, a transmission time may refer to a start time of frame transmission and/or an end time (e.g. completion time) of frame transmission, while a reception time may refer to a start time of frame reception and/or an end time (e.g. completion time) of frame reception. The term ‘time’ may be interpreted as a time point depending on a context.

In the present disclosure, a phrase including “when ˜” may be expressed as a phrase including “based on ˜” or a phrase including “in response to ˜”. In other words, a phrase including “when ˜” may be interpreted as being the same as or similar to a phrase including “based on ˜” or a phrase including “in response to ˜”.

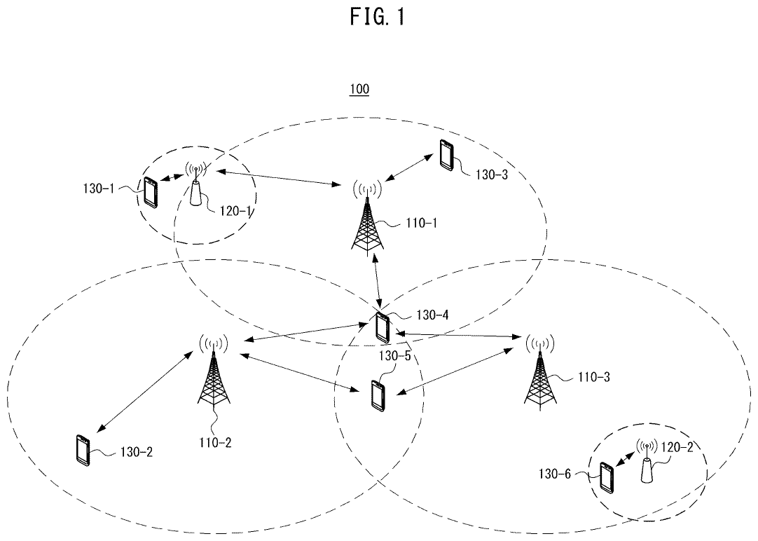

FIG. 1 is a conceptual diagram illustrating a first exemplary embodiment of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. Also, the communication system 100 may further comprise a core network (e.g. a serving gateway (S-GW), a packet data network (PDN) gateway (P-GW), and a mobility management entity (MME)). When the communication system 100 is a 5G communication system (e.g. New Radio (NR) system), the core network may include an access and mobility management function (AMF), a user plane function (UPF), a session management function (SMF), and the like.

The plurality of communication nodes 110 to 130 may support communication protocols defined in the 3rd generation partnership project (3GPP) technical specifications (e.g. LTE communication protocol, LTE-A communication protocol, NR communication protocol, or the like). The plurality of communication nodes 110 to 130 may support code division multiple access (CDMA) based communication protocol, wideband CDMA (WCDMA) based communication protocol, time division multiple access (TDMA) based communication protocol, frequency division multiple access (FDMA) based communication protocol, orthogonal frequency division multiplexing (OFDM) based communication protocol, filtered OFDM based communication protocol, cyclic prefix OFDM (CP-OFDM) based communication protocol, discrete Fourier transform-spread-OFDM (DFT-s-OFDM) based communication protocol, orthogonal frequency division multiple access (OFDMA) based communication protocol, single carrier FDMA (SC-FDMA) based communication protocol, non-orthogonal multiple access (NOMA) based communication protocol, generalized frequency division multiplexing (GFDM) based communication protocol, filter band multi-carrier (FBMC) based communication protocol, universal filtered multi-carrier (UFMC) based communication protocol, space division multiple access (SDMA) based communication protocol, or the like. Each of the plurality of communication nodes may have a structure below.

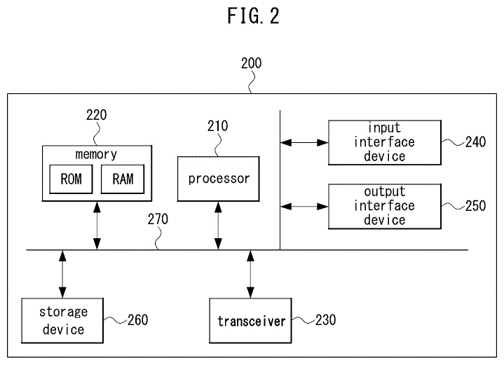

FIG. 2 is a block diagram illustrating a first exemplary embodiment of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. The respective components included in the communication node 200 may communicate with each other as connected through a bus 270.

However, each component included in the communication node 200 may not be connected to the common bus 270 but may be connected to the processor 210 via an individual interface or a separate bus. For example, the processor 210 may be connected to at least one of the memory 220, the transceiver 230, the input interface device 240, the output interface device 250 and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to the cell coverage of the first base station 110-1. Also, the second terminal 130-2, the fourth terminal 130-4, and the fifth terminal 130-5 may belong to the cell coverage of the second base station 110-2. Also, the fifth base station 120-2, the fourth terminal 130-4, the fifth terminal 130-5, and the sixth terminal 130-6 may belong to the cell coverage of the third base station 110-3. Also, the first terminal 130-1 may belong to the cell coverage of the fourth base station 120-1, and the sixth terminal 130-6 may belong to the cell coverage of the fifth base station 120-2.

Here, each of the plurality of base stations 110-1, 110-2, 110-3, 120-1, and 120-2 may be referred to as NodeB (NB), evolved NodeB (eNB), gNB, advanced base station (ABS), high reliability-base station (HR-BS), base transceiver station (BTS), radio base station, radio transceiver, access point (AP), access node, radio access station (RAS), mobile multi-hop relay-base station (MMR-BS), relay station (RS), advanced relay station (ARS), high reliability-relay station (HR-RS), home NodeB (HNB), home eNodeB (HeNB), road side unit (RSU), radio remote head (RRH), transmission point (TP), transmission and reception point (TRP), or the like.

Each of the plurality of terminals 130-1, 130-2, 130-3, 130-4, 130-5, and 130-6 may be referred to as user equipment (UE), terminal equipment (TE), advanced mobile station (AMS), high reliability-mobile station (HR-MS), terminal, access terminal, mobile terminal, station, subscriber station, mobile station, portable subscriber station, node, device, on-board unit (OBU), or the like.

Meanwhile, each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul link or a non-ideal backhaul link, and exchange information with each other via the ideal or non-ideal backhaul. Also, each of the plurality of base stations 110-1, 110-2, 110-3, 120-1, and 120-2 may be connected to the core network through the ideal backhaul link or non-ideal backhaul link. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

In addition, each of the plurality of base stations 110-1, 110-2, 110-3, 120-1, and 120-2 may support a multi-input multi-output (MIMO) transmission (e.g. single-user MIMO (SU-MIMO), multi-user MIMO (MU-MIMO), massive MIMO, or the like), a coordinated multipoint (COMP) transmission, a carrier aggregation (CA) transmission, a transmission in unlicensed band, a device-to-device (D2D) communication (or, proximity services (ProSe)), an Internet of Things (IoT) communication, a dual connectivity (DC), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2 (i.e. the operations supported by the plurality of base stations 110-1, 110-2, 110-3, 120-1, and 120-2). For example, the second base station 110-2 may transmit a signal to the fourth terminal 130-4 in the SU-MIMO manner, and the fourth terminal 130-4 may receive the signal from the second base station 110-2 in the SU-MIMO manner. Alternatively, the second base station 110-2 may transmit a signal to the fourth terminal 130-4 and fifth terminal 130-5 in the MU-MIMO manner, and the fourth terminal 130-4 and fifth terminal 130-5 may receive the signal from the second base station 110-2 in the MU-MIMO manner.

Each of the first base station 110-1, the second base station 110-2, and the third base station 110-3 may transmit a signal to the fourth terminal 130-4 in the CoMP transmission manner, and the fourth terminal 130-4 may receive the signal from the first base station 110-1, the second base station 110-2, and the third base station 110-3 in the COMP manner. Also, each of the plurality of base stations 110-1, 110-2, 110-3, 120-1, and 120-2 may exchange signals with the corresponding terminals 130-1, 130-2, 130-3, 130-4, 130-5, or 130-6 which belongs to its cell coverage in the CA manner. Each of the base stations 110-1, 110-2, and 110-3 may control D2D communications between the fourth terminal 130-4 and the fifth terminal 130-5, and thus the fourth terminal 130-4 and the fifth terminal 130-5 may perform the D2D communications under control of the second base station 110-2 and the third base station 110-3.

Hereinafter, operation methods of a communication node in a communication network will be described. Even when a method (e.g. transmission or reception of a signal) to be performed at a first communication node among communication nodes is described, a corresponding second communication node may perform a method (e.g. reception or transmission of the signal) corresponding to the method performed at the first communication node. That is, when an operation of a terminal is described, a corresponding base station may perform an operation corresponding to the operation of the terminal. Conversely, when an operation of a base station is described, a corresponding terminal may perform an operation corresponding to the operation of the base station.

### Definition of Terms

In the present disclosure, methods and procedures for controlling beam DRX (or beam DRX operations) of a terminal belonging to a terminal group located in a beam service area of a downlink beam (e.g. a specific beam service area, a common service area or a specific beam group service area within a serving cell) are described. The beam DRX may refer to a DRX operation of a terminal that is performed at a beam level. In other words, the beam DRX may refer to a DRX operation of a terminal for each of beams formed by a base station. A DRX beam may refer to a beam through which a signal that is a target of the beam DRX operation of the terminal is transmitted.

### Operations of a Base Station for Beam DRX Control

### UE DRX Beam Configuration Information

A base station may transmit UE DRX beam configuration information to terminal groups in order to configure beam DRX operations of the terminal groups according to a type of a beam service area (e.g. a specific beam service area, a specific beam group service area, or a cell-common service area). The UE DRX beam configuration information may include at least one of DRX beam information, DRX beam group information, or cell-common DRX beam information.

The DRX beam information may be information for configuring a beam DRX operation of a terminal group belonging to a specific beam service area. The DRX beam information may include at least one of beam information associated with a beam received by a terminal group belonging to the specific beam service area, a DRX beam terminal group temporary identifier (DrxBeamUeGroup-radio network temporary identifier (RNTI)) corresponding to the received beam, or information on a DRX beam service duration for a beam DRX operation associated with the received beam.

The DRX beam group information may be information for configuring beam DRX operations of terminal groups belonging to a specific beam group service area. The DRX beam group information may include at least one of beam information associated with each of beams received by the terminal groups belonging to the specific beam group service area, a DRX beam group temporary identifier (DrxBeamGroup-RNTI) corresponding to a beam group including the received beams, or information on a DRX beam service duration for a beam DRX operation associated with the beam group.

The cell-common DRX beam information may be information for configuring beam DRX operations of terminal groups belonging to a cell-common service area. The cell-common DRX beam information may include at least one of beam information associated with each of beams belonging to a cell, a cell-common DRX beam temporary identifier (CellCommonDrxBeam-RNTI) corresponding to the cell, or information on a DRX beam service duration for a beam DRX operation associated with beams belonging to the cell.

In another example, the UE DRX beam configuration information may include at least one of beam information associated with a beam received by a terminal group, a temporary identifier corresponding to a type of a beam service area, or information on a DRX beam service duration for a beam DRX operation for the received beam.

The information on the DRX beam service duration may include at least one of an on-duration, an off-duration (or sleep duration), a DRX cycle, or a DRX offset. The on-duration may refer to a time duration in which reception for a specific beam is activated when beam DRX is activated. The off-duration may refer to a time duration in which reception for a specific beam is deactivated. The DRX cycle may be a time duration including the on-duration and the off-duration. The DRX cycle may be repeated. In other words, one DRX beam service duration may include a plurality of DRX cycles. The DRX offset (or a cycle on-duration offset) may indicate when an on-duration or an off-duration starts within a cycle. In other words, the DRX offset may indicate how much time elapses from a reference time (e.g. start time) within a DRX cycle until an on-duration or an off-duration starts.

The beam information may include at least one of identification information for identifying a beam (e.g. beam ID), information on a reference signal transmitted through the beam (e.g. a type of the reference signal, resources to which the reference signal is mapped), or a transmission configuration indicator (TCI) state associated with the reference signal. The TCI state may indicate spatial channel characteristics of the beam through a quasi-co-location (QCL) relationship between the reference signal and an antenna port. A plurality of beams may be identified by the beam information. The identified plurality of beams may belong to different cells.

The DRX beam terminal group temporary identifier, the DRX beam group temporary identifier, and the cell-common DRX beam temporary identifier may be temporary identifiers for terminals belonging to a terminal group to receive UE DRX beam control information according to a type of a beam service area (e.g. a specific beam service area, a specific beam group service area, or a cell-common service area) configured by the UE DRX beam configuration information.

Hereinafter, an example in which transmission of UE DRX beam configuration information is performed when a terminal enters a beam service area will be described. A terminal #1 may enter a beam service area #A from a beam service area #B. A terminal group #A belonging to the beam service area #A may receive UE DRX beam configuration information including a DRX beam terminal group temporary identifier before the terminal #1 enters the beam service area #A. The terminal group #A may have already been performing a beam DRX operation for a beam #A covering the beam service area #A when the terminal #1 enters the beam service area #A. A base station may transmit the UE DRX beam configuration information to the terminal #1 that has entered the beam service area #A. The UE DRX beam configuration information may include information indicating that beam DRX is already being performed in the beam service area #A or information indicating activation of a beam DRX operation for the beam #A. The terminal #1 that has entered the beam service area #A may maintain continuity of the beam DRX operation through the UE DRX beam configuration information. The base station may not generate a separate configuration for beam DRX of the terminal #1. In other words, the base station may reuse a configuration for beam DRX operations of terminals belonging to the beam service area #A for the terminal #1.

Hereinafter, another example in which transmission of UE DRX beam configuration information is performed when a terminal enters a specific beam service area will be described. A terminal #1 may enter a beam service area #A from a beam service area #B. A terminal group #A belonging to the beam service area #A may receive UE DRX beam configuration information including a cell-common DRX beam temporary identifier before the terminal #1 enters the beam service area #A. The terminal group #A may have already been performing a beam DRX operation for a beam #A covering the beam service area #A before the terminal #1 enters the beam service area #A. Since the terminal #1 has already received the UE DRX beam configuration information including the cell-common DRX beam temporary identifier that the terminal group #A received before the terminal #1 enters the beam service area #A, the base station may not transmit the UE DRX beam configuration information to the terminal #1 that has entered the beam service area #A. The terminal #1 may monitor UE DRX beam control information indicating activation of a beam DRX operation for the beam #A through the cell-common DRX beam temporary identifier even without receiving separate UE DRX configuration information after entering the beam service area #A. Accordingly, the terminal #1 may perform a beam DRX operation for the beam #A even without receiving separate UE DRX configuration information after entering the beam service area #A. The base station may not transmit new UE DRX beam control information for the terminal #1.

The base station may control a monitoring operation for a terminal to receive a physical downlink control channel (PDCCH) including DCI through a temporary identifier included in the UE DRX beam configuration information. The PDCCH may include DCI having a cyclic redundancy check (CRC) scrambled by the temporary identifier. The DCI may include UE DRX beam control information. The CRC may be determined through a CRC parity bit calculation using a DCI bit sequence. A reason why the CRC is configured in the PDCCH together with the DCI may be as follows. A specific terminal or terminal group may check whether the received DCI includes an error and may confirm that the DCI is intended for the specific terminal or terminal group.

According to a type of the temporary identifier, the UE DRX beam control information may be received by one or more terminal groups. The type of the temporary identifier may be one of a DRX beam terminal group temporary identifier, a DRX beam group temporary identifier, or a cell-common DRX beam temporary identifier. The DRX beam terminal group temporary identifier may correspond to one beam. The DRX beam group temporary identifier may correspond to two or more beams. The cell-common DRX beam temporary identifier may correspond to one cell.

For example, the base station may transmit UE DRX beam configuration information including a DRX beam terminal group temporary identifier #A to a terminal group #A belonging to a beam service area #A. A terminal belonging to the terminal group #A may perform a monitoring operation for receiving a PDCCH including DCI including UE DRX beam control information by using the DRX beam terminal group temporary identifier #A after receiving the UE DRX beam configuration information. The DCI included in the PDCCH may include a CRC scrambled with the DRX beam terminal group temporary identifier #A. Accordingly, a terminal group #B and a terminal group #C may not receive the PDCCH including the DCI having the CRC scrambled with the DRX beam UE group temporary identifier #A.

In another example, the base station may transmit UE DRX beam configuration information including a cell-common DRX temporary identifier to the terminal group #A belonging to the beam service area #A, the terminal group #B, and the terminal group #C. A terminal belonging to the terminal group #A may perform a monitoring operation for receiving a PDCCH including DCI including UE DRX beam control information by using the cell-common DRX temporary identifier after receiving the UE DRX beam configuration information. A terminal belonging to the terminal group #B may perform a monitoring operation for receiving a PDCCH including DCI including UE DRX beam control information by using the cell-common DRX temporary identifier after receiving the UE DRX beam configuration information. A terminal belonging to the terminal group #C may perform a monitoring operation for receiving a PDCCH including DCI including UE DRX beam control information by using the cell-common DRX temporary identifier after receiving the UE DRX beam configuration information. A CRC of the DCI included in the PDCCH may be scrambled with the cell-common DRX beam temporary identifier. Accordingly, not only the terminal group #A but also the terminal group #B and the terminal group #C may receive the PDCCH including the DCI having the CRC scrambled with the cell-common DRX beam temporary identifier.

In another example, the base station may transmit UE DRX beam configuration information including the DRX beam group temporary identifier #a to the terminal group #C belonging to a beam service area #C. The beam service area #C may be a beam service area covered by a beam #T1 and a beam #T2. A beam group #a may include the beam #T1 and the beam #T2. The same on-duration may be configured for beams included in the beam group #a based on the UE DRX beam configuration information or UE DRX beam control information. A terminal belonging to the terminal group #C may perform a monitoring operation for receiving a PDCCH including DCI including UE DRX beam control information by using the DRX beam group temporary identifier #a after receiving the UE DRX beam configuration information. A CRC of the DCI included in the PDCCH may be scrambled with the DRX beam group temporary identifier #a. Accordingly, the terminal group #A and the terminal group #B may not receive the PDCCH including the DCI having the CRC scrambled with the DRX beam group temporary identifier #a.

Signal(s) transmitted by the base station to a terminal belonging to a terminal group through a beam may be at least one of a synchronization signal (SS), a synchronization signal block (SSB), a reference signal (RS), a PDCCH, or a physical downlink shared channel (PDSCH). The reference signal may be one of a channel state information-reference signal (CSI-RS) for acquisition of CSI, a CSI-RS for beam management, a tracking reference signal (TRS) for time tracking, or a phase tracking (PT)-RS used for phase estimation of a PDSCH.

### UE DRX Beam Control Information

The UE DRX beam control information may include at least one of beam information, information indicating activation or deactivation of beam DRX of a terminal for a beam indicated by the beam information, or information on a DRX beam service duration for the beam. When the UE DRX beam control information is control information for controlling a beam group, the UE DRX beam control information may include at least one of beam information, information indicating activation or deactivation of beam DRX of a terminal for a plurality of beams indicated by the beam information, or information on a DRX beam service duration for the plurality of beams.

The DRX beam service duration indicated by the UE DRX beam control information may be the same as the DRX beam service duration indicated by the UE DRX beam configuration information. Information on the DRX beam service duration indicated by the UE DRX beam control information may include at least one of an on-duration, an off-duration (or sleep duration), a DRX cycle, or a DRX offset. The on-duration may refer to a time duration in which reception for a specific beam is activated when beam DRX is activated. The off-duration may refer to a time duration in which reception for a specific beam is deactivated. The DRX cycle may be a time duration including the on-duration and the off-duration. The DRX cycle may be repeated. In other words, one DRX beam service duration may include a plurality of DRX cycles. The DRX offset (or a cycle on-duration offset) may indicate when an on-duration or an off-duration starts within a DRX cycle. In other words, the DRX offset may indicate how much time elapses from a reference time within a DRX cycle (e.g. a start time of the DRX cycle) until an on-duration or an off-duration starts. For example, beam DRX operations based on the same DRX cycle may be performed for different DRX beams. However, different DRX offsets may be configured for different DRX beams. Different DRX beams may have different on-durations or different off-durations according to the different DRX offsets. The on-durations or the off-durations being different may mean that lengths of an on-duration and an off-duration are different and/or that positions of a start time of an on-duration or a start time of an off-duration within a DRX cycle are different.

The beam information indicated by the UE DRX beam control information may be the same as the beam information indicated by the UE DRX beam configuration information. The beam information may include at least one of identification information for identifying a beam (e.g. beam ID), information on a reference signal transmitted through the beam (e.g. a type of the reference signal, resources to which the reference signal is mapped), or a TCI state associated with the reference signal. The TCI state may indicate spatial channel characteristics of the beam through a QCL relationship between the reference signal and an antenna port.

The UE DRX beam control information may be transmitted to a terminal belonging to a terminal group through DCI included in a PDCCH. Alternatively, the UE DRX beam control information may be transmitted to a terminal belonging to a terminal group through a downlink data transmission (e.g. PDSCH) scheduled by a PDCCH.

The base station may transmit an indication instructing a terminal belonging to a terminal group to perform measurement for a beam covering a beam service area to which the terminal group belongs. The terminal belonging to the terminal group may perform measurement for the beam covering the beam service area to which the terminal belongs according to the received indication. The measurement may be measurement for reference signals received through the beam. The terminal may transmit a measurement report or a CSI report to the base station after performing the measurement. The measurement report or the CSI report may include at least one of a power level of reference signals received by the terminal through the beam, channel quality information (CQI) of a channel experienced by the reference signals received by the terminal through the beam, or information on reference signals indicating beams that the terminal is able to receive. In another example, the terminal may transmit a beam report to the base station after performing measurement for a beam through which reference signal(s) are received. The beam report may include at least one of a measurement report including measurement results for the beam or a channel state report including CSI of the channel through the beam between the base station and the terminal.

The base station may determine whether to activate or deactivate UE DRX for a beam covering a beam service area in consideration of at least one of the measurement report or the CSI report of the terminal, the number of terminals located in the beam service area, a traffic load, or an energy state of a network. The energy state of the network may be an energy state of the network to which the base station belongs. The energy state of the network may indicate at least one of an amount of energy consumed by the network or energy consumption efficiency.

When the base station determines whether to activate or deactivate beam DRX of the terminal for the beam covering the beam service area, the base station may generate UE DRX beam control information indicating activation or deactivation of beam DRX of the terminal. The base station may transmit, through a PDCCH, DCI having a CRC scrambled by using a temporary identifier included in UE DRX beam configuration information to terminals belonging to the terminal group. The PDCCH may include DCI, and the DCI may include the generated UE DRX beam control information. The terminal group monitoring the PDCCH may identify whether the terminal group receives the DCI transmitted through the PDCCH by descrambling the CRC of the DCI transmitted through the PDCCH by using the temporary identifier used for scrambling.

For example, when the temporary identifier used for scrambling the CRC included in the DCI of the PDCCH is a cell-common DRX beam temporary identifier, terminal groups belonging to a cell corresponding to the cell-common DRX beam temporary identifier may receive the PDCCH. However, a terminal group not belonging to the beam service area covered by the beam indicated by the beam information included in the UE DRX beam control information may not perform activation or deactivation of beam DRX.

In another example, when the temporary identifier used for scrambling the CRC included in the DCI of the PDCCH is a DRX beam group temporary identifier, terminal groups belonging to beam service area(s) covered by beams included in a beam group corresponding to the DRX beam group temporary identifier may receive the PDCCH. Each terminal group that has received the PDCCH may perform activation or deactivation for a beam covering a beam service area to which the terminal group belongs based on the UE DRX beam control information.

In another example, when the temporary identifier used for scrambling the CRC included in the DCI of the PDCCH is a DRX beam terminal group temporary identifier, a terminal group belonging to a beam service area covered by a beam corresponding to the DRX beam terminal group temporary identifier may receive the PDCCH. The terminal group that has received the PDCCH may perform activation or deactivation for a beam covering a beam service area to which the terminal group belongs based on the UE DRX beam control information.

The base station may perform downlink transmission in an on-duration indicated by the UE DRX beam control information. When the base station determines deactivation of beam DRX for a beam #B, the base station may transmit, to a terminal group belonging to a beam service area of the beam #B, a PDCCH including DCI having a CRC scrambled by one temporary identifier among a DRX beam terminal group temporary identifier, a DRX beam group temporary identifier, or a cell-common DRX beam temporary identifier. The DCI included in the PDCCH may include UE DRX beam control information.

For example, a DRX beam terminal group temporary identifier transmitted to a terminal group belonging to the beam service area of the beam #B may correspond to the beam #B. In another example, a DRX beam group temporary identifier transmitted to a terminal group belonging to the beam service area of the beam #B may correspond to a beam group including the beam #B. In another example, a cell-common DRX beam temporary identifier transmitted to a terminal group belonging to the beam service area of the beam #B may correspond to a cell including the beam #B.

The base station may stop a transmission operation of downlink signal(s) during an off-duration based on at least one of UE DRX beam configuration information or DRX beam control information provided to a terminal according to a beam service area of a downlink beam. In other words, the base station may perform downlink beam DTX based on a DRX beam service duration indicated by the UE DRX beam configuration information or UE DRX beam control information.

The base station performing the downlink beam DTX may transmit signals to a terminal belonging to a terminal group through a downlink beam during an on-duration, and may not transmit signals during an off-duration. The signals that are targets of the downlink beam DTX of the base station may include at least one of a synchronization signal (SS), a synchronization signal block (SSB), a reference signal (RS), a PDCCH, or a PDSCH. The reference signal may be one of a CSI-RS for CSI acquisition and beam management, a tracking reference signal (TRS) for time tracking, or a phase tracking (PT)-RS used for phase estimation of a PDSCH.

### Operations of a Terminal for Beam DRX Control

### UE DRX Beam Configuration Information

A terminal may receive UE DRX beam configuration information from a base station for controlling a beam DRX operation of a terminal group according to a type of a beam service area (e.g. a specific beam service area, a specific beam group service area, or a cell-common service area). The UE DRX beam configuration information may include at least one of DRX beam information, DRX beam group information, or cell-common DRX beam information.

The DRX beam information may be information for configuring a beam DRX operation of a terminal group belonging to a specific beam service area. The DRX beam information may include at least one of beam information associated with a beam received by the terminal group belonging to the specific beam service area, a DRX beam terminal group temporary identifier DrxBeamUeGroup-RNTI corresponding to the received beam, or information on a DRX beam service duration for a beam DRX operation associated with the received beam.

The DRX beam group information may be information for configuring beam DRX operations of terminal groups belonging to a specific beam group service area. The DRX beam group information may include at least one of beam information associated with each of beams received by the terminal groups belonging to the specific beam group service area, a DRX beam group temporary identifier DrxBeamGroup-RNTI corresponding to a beam group including the received beams, or information on a DRX beam service duration for a beam DRX operation associated with the beam group.

The cell-common DRX beam information may be information for configuring beam DRX operations of terminal groups belonging to a cell-common service area. The cell-common DRX beam information may include at least one of beam information associated with each of beams belonging to a cell, a cell-common DRX beam temporary identifier CellCommonDrxBeam-RNTI corresponding to the cell, or information on a DRX beam service duration for a beam DRX operation associated with beams belonging to the cell.

In another example, the UE DRX beam configuration information may include at least one of beam information associated with a beam received by a terminal group, a temporary identifier corresponding to a beam service area, or information on a DRX beam service duration for a beam DRX operation for the received beam.

The information on the DRX beam service duration may include at least one of an on-duration, an off-duration (or sleep duration), a DRX cycle, or a DRX offset. The on-duration may refer to a time duration in which reception for a specific beam is activated when beam DRX is activated. The off-duration may refer to a time duration in which reception for a specific beam is deactivated. The DRX cycle may be a time duration including the on-duration and the off-duration. The DRX cycle may be repeated. In other words, one DRX beam service duration may include a plurality of DRX cycles. The DRX offset (or a cycle on-duration offset) may indicate when an on-duration or an off-duration starts within a cycle. In other words, the DRX offset may indicate how much time elapses from a reference time (e.g. a start time) within a DRX cycle until an on-duration or an off-duration starts.

The beam information may include at least one of identification information for identifying a beam (e.g. beam ID), information on a reference signal transmitted through the beam (e.g. a type of the reference signal, resources to which the reference signal is mapped), or a TCI state associated with the reference signal. The TCI state may indicate spatial channel characteristics of the beam through a QCL relationship between the reference signal and an antenna port. A plurality of beams may be identified by the beam information. The identified plurality of beams may belong to different cells.

The DRX beam terminal group temporary identifier, the DRX beam group temporary identifier, and the cell-common DRX beam temporary identifier may be temporary identifiers for terminals belonging to a terminal group to receive UE DRX beam control information according to a type of a beam service area (e.g. a specific beam service area, a specific beam group service area, or a cell-common service area) configured by the UE DRX beam configuration information.

When a terminal receives the UE DRX beam configuration information, the terminal may enter a beam DRX deactivated state. In other words, the terminal may enter a preparation state for activating a beam DRX operation for a beam covering a beam service area to which the terminal belongs when the terminal receives the UE DRX beam configuration information. When a terminal receives the UE DRX beam configuration information, the terminal may perform a monitoring operation for receiving a PDCCH including DCI including UE DRX beam control information indicating activation of beam DRX by using a temporary identifier (e.g. DrxBeamUeGroup-RNTI, CellCommonDrxBeam-RNTI, or DrxBeamGroup-RNTI) included in the UE DRX beam configuration information.

Hereinafter, an example in which reception of UE DRX beam configuration information is performed when a terminal enters a beam service area is described. A terminal #1 may enter a beam service area #A from a beam service area #B. A terminal group #A belonging to the beam service area #A may receive UE DRX beam configuration information including a DRX beam terminal group temporary identifier before the terminal #1 enters the beam service area #A. The terminal group #A may have already been performing a beam DRX operation for a beam #A covering the beam service area #A before the terminal #1 enters the beam service area #A. The terminal #1 that has entered the beam service area #A may receive UE DRX beam configuration information from the base station. The UE DRX beam configuration information may include information indicating that beam DRX is already being performed in the beam service area #A or information indicating activation of a beam DRX operation for the beam #A. The terminal #1 that has entered the beam service area #A may maintain continuity of the beam DRX operation through the UE DRX beam configuration information. The base station may not generate a separate configuration for beam DRX of the terminal #1. In other words, the base station may reuse a configuration for beam DRX operations of terminals belonging to the beam service area #A for the terminal #1.

Hereinafter, an example in which a terminal performs activation of a beam DRX operation after a time duration corresponding to a DRX offset is described. A terminal for which a beam DRX operation has already been configured through UE DRX beam configuration information including a DRX beam terminal group temporary identifier or a DRX beam group temporary identifier may activate beam DRX after a time duration corresponding to a DRX offset. When the terminal moves from a beam service area of a neighboring beam to a beam service area of a current beam, the terminal may activate beam DRX after the time duration corresponding to the DRX offset.

In other words, before movement of the terminal, the terminal may receive UE DRX beam configuration information including a DRX beam terminal group temporary identifier or a DRX beam group temporary identifier. Before movement of the terminal, the terminal may activate beam DRX. The terminal having activated beam DRX may, after a time duration corresponding to a DRX offset, maintain continuous beam DRX after movement of the terminal from a beam service area of a neighboring beam to a beam service area of a current beam. However, existing terminals in the beam service area of the current beam may perform a beam DRX operation according to an already configured DRX cycle. The terminal that has moved to the beam service area of the current beam may perform a monitoring operation for receiving a PDCCH including DCI including UE DRX beam control information by using the DRX beam terminal group temporary identifier or DRX beam group temporary identifier. The UE DRX beam control information received by the terminal that has moved to the beam service area of the current beam may include information indicating deactivation of beam DRX or control information for performing a beam DRX operation in the beam service area of the current beam.

Terminal groups belonging to a cell-common service area may receive UE DRX beam configuration information including a cell-common DRX beam temporary identifier from a base station. The terminal #1 may enter the beam service area #A. The terminal #1 may have already received UE DRX beam configuration information including the cell-common DRX beam temporary identifier before the terminal #1 enters the beam service area #A. Accordingly, the terminal #1 may not receive separate UE DRX beam configuration information even when the terminal #1 enters the beam service area #A. The terminal #1 that has entered the beam service area #A may perform a monitoring operation for receiving a PDCCH including DCI including UE DRX beam control information by using the cell-common DRX beam temporary identifier. The terminal may receive the UE DRX beam control information through the beam #A covering the beam service area #A. The UE DRX beam control information received by the terminal #1 that has entered the beam service area #A may include information indicating activation of beam DRX for the beam #A covering the beam service area #A. The terminal may perform a beam DRX operation for the beam #A based on the UE DRX beam control information.

Hereinafter, three types of scheduling of UE DRX beam control information are described. The type of scheduling of the UE DRX beam control information may vary according to a type of a temporary identifier included in UE DRX beam configuration information (e.g. a DRX beam terminal group temporary identifier DrxBeamUeGroup-RNTI, a cell-common DRX beam temporary identifier CellCommonDrxBeam-RNTI, or a DRX beam group temporary identifier DrxBeamGroup-RNTI).

A terminal belonging to a terminal group located in a beam service area may receive UE DRX beam configuration information including a DRX beam terminal group temporary identifier. The beam service area may be configured as a specific beam service area. The DRX beam terminal group temporary identifier may correspond to the beam service area or to a beam covering the beam service area. In other words, a terminal belonging to a terminal group located in the beam service area corresponding to the DRX beam terminal group temporary identifier may perform a monitoring operation for receiving a PDCCH including DCI including UE DRX beam control information through the DRX beam terminal group temporary identifier.

A terminal belonging to a terminal group located in a beam service area may receive UE DRX beam configuration information including a cell-common DRX beam temporary identifier. The beam service area may be configured as a cell-common service area. The cell-common DRX beam temporary identifier may correspond to a cell to which the beam service area belongs or to a cell to which a beam covering the beam service area belongs. The terminal that has received the UE DRX beam configuration information may perform a monitoring operation for receiving a PDCCH including DCI including UE DRX beam control information through the cell-common DRX beam temporary identifier. In other words, terminals belonging to terminal groups located in the cell corresponding to the cell-common DRX beam temporary identifier may perform a monitoring operation for receiving a PDCCH including DCI including UE DRX beam control information through the cell-common DRX beam temporary identifier.

A terminal belonging to a terminal group located in a beam service area may receive UE DRX beam configuration information including a DRX beam group temporary identifier. The beam service area may be configured as a specific beam group service area. The DRX beam group temporary identifier may correspond to a beam group to which a beam covering the beam service area belongs. The terminal that has received the UE DRX beam configuration information may perform a monitoring operation for receiving a PDCCH including DCI including UE DRX beam control information through the DRX beam group temporary identifier. The same on-duration may be configured for beams belonging to the beam group. In other words, terminals belonging to terminal groups located in beam service areas covered by the beam group corresponding to the DRX beam group temporary identifier may perform a monitoring operation for receiving a PDCCH including DCI including UE DRX beam control information through the specific beam group service area.

A terminal that has received the UE DRX beam configuration information may decode a PDCCH including DCI having a CRC scrambled with a temporary identifier (e.g. a DRX beam terminal group temporary identifier DrxBeamUeGroup-RNTI, a cell-common DRX beam temporary identifier CellCommonDrxBeam-RNTI, or a DRX beam group temporary identifier DrxBeamGroup-RNTI). When decoding of the PDCCH is successful, the terminal may receive or obtain UE DRX beam control information through the DCI included in the PDCCH. In another example, when decoding of the PDCCH is successful, the terminal may receive or obtain UE DRX beam control information through a downlink data transmission scheduled by the PDCCH.

Downlink signal(s) received by a terminal belonging to a terminal group from a base station through a beam may include at least one of a synchronization signal, a synchronization signal block, a reference signal, a PDCCH, or a PDSCH. The reference signal may be one of a reference signal for acquisition of CSI, a CSI-RS for beam management, a TRS for time tracking, or a PT-RS used for phase estimation of a PDSCH.

### UE DRX Beam Control Information

The UE DRX beam control information may include at least one of beam information, information indicating activation or deactivation of beam DRX for a beam indicated by the beam information, or information on a DRX beam service duration for the beam. When the UE DRX beam control information is control information for controlling a beam group, the UE DRX beam control information may include at least one of beam information, information indicating activation or deactivation of beam DRX for a plurality of beams indicated by the beam information, or information on a DRX beam service duration for the plurality of beams.

The DRX beam service duration indicated by the UE DRX beam control information may be the same as the DRX beam service duration indicated by the UE DRX beam configuration information. Information on the DRX beam service duration indicated by the UE DRX beam control information may include at least one of an on-duration, an off-duration (or a sleep duration), a DRX cycle, or a DRX offset. The on-duration may refer to a time duration during which reception for a specific beam is activated when beam DRX is activated. The off-duration may refer to a time duration during which reception for a specific beam is deactivated. The DRX cycle may be a time duration including the on-duration and the off-duration. The DRX cycle may be repeated. In other words, one DRX beam service duration may include a plurality of DRX cycles. The DRX offset (or a cycle on-duration offset) may indicate when an on-duration or an off-duration starts within a cycle. In other words, the DRX offset may indicate how much time elapses from a reference time (e.g. start time) within the DRX cycle until an on-duration or an off-duration starts.

The beam information indicated by the UE DRX beam control information may be the same as the beam information indicated by the UE DRX beam configuration information. The beam information may include at least one of identification information for identifying a beam (e.g. beam ID), information on a reference signal transmitted through the beam (e.g. a type of the reference signal, and resources to which the reference signal is mapped), or a TCI state associated with the reference signal. The TCI state may indicate spatial channel characteristics of the beam through a QCL relationship between the reference signal and an antenna port.

The UE DRX beam control information may be transmitted to a terminal belonging to a terminal group through DCI included in a PDCCH. Alternatively, the UE DRX beam control information may be transmitted to a terminal belonging to a terminal group through a downlink data transmission (e.g. PDSCH) scheduled by a PDCCH.

A terminal belonging to a terminal group may receive, from a base station, an indication instructing the terminal to perform measurement on a beam covering a beam service area to which the terminal group belongs. The terminal belonging to the terminal group may perform measurement on the beam covering the beam service area to which the terminal belongs according to the received indication. The measurement may be a measurement on reference signal(s) received through the beam. After performing the measurement, the terminal may transmit a measurement report or a CSI report to the base station. The measurement report or the CSI report may include at least one of power of reference signals received by the terminal through the beam, CQI of a channel experienced by the reference signal received by the terminal through the beam, or information on reference signals indicating beams that the terminal is able to receive.

In order to receive UE DRX beam control information according to a type of a beam service area (e.g. a specific beam service area, a specific beam group service area, or a cell-common service area), the UE DRX beam configuration information may include at least one of various types of temporary identifiers (e.g. a DRX beam terminal group temporary identifier, a DRX beam group temporary identifier, or a cell-common DRX beam temporary identifier). A terminal that has received the UE DRX beam configuration information may perform a monitoring operation for receiving a PDCCH including DCI including UE DRX beam control information through a temporary identifier. In other words, a monitoring operation of the terminal may be controlled according to a type of a temporary identifier included in the UE DRX beam configuration information.

For example, a terminal may receive UE DRX beam configuration information including a DRX terminal group temporary identifier #i. The DRX terminal group temporary identifier #i may correspond to a beam #i. In other words, the DRX terminal group temporary identifier #i may be a temporary identifier for a beam DRX operation for the beam #i. The terminal may perform a monitoring operation for receiving a PDCCH including DCI including UE DRX beam control information for controlling beam DRX for the beam #i through the DRX terminal group temporary identifier #i in a beam service area #i covered by the beam #i. The UE DRX beam control information may be transmitted through the beam #i.

The UE DRX beam control information for control of the beam #i may indicate activation of beam DRX for the beam #i. A terminal that has received the UE DRX beam control information for control of the beam #i may perform activation of beam DRX for the beam #i. The terminal that has performed activation of beam DRX for the beam #i may perform a beam DRX operation for the beam #i according to a DRX beam service duration indicated by the UE DRX beam configuration information or UE DRX beam control information. The terminal may be in a wake-up state during an on-duration indicated by the UE DRX beam configuration information or UE DRX beam control information. The terminal in the wake-up state may perform downlink reception through the beam #i. The terminal may be in a sleep state or an energy saving state during an off-duration indicated by the UE DRX beam configuration information or UE DRX beam control information. The terminal in the sleep state may stop downlink reception through the beam #i.

The UE DRX beam control information for control of the beam #i may include at least one of beam information corresponding to the beam #i, information indicating activation or deactivation of beam DRX for the beam #i, or information on a DRX beam service duration for a beam DRX operation for the beam #i.

A terminal may receive UE DRX beam configuration information including a cell-common DRX beam temporary identifier. The terminal may perform a monitoring operation for receiving a PDCCH including DCI including UE DRX beam control information for control of beam DRX for a beam #j through the cell-common DRX beam temporary identifier in a cell to which a beam service area #j covered by the beam #j belongs. The UE DRX beam control information may be transmitted through the beam #j.

The UE DRX beam control information for control of the beam #j may indicate activation of beam DRX for the beam #j. The terminal that has received the UE DRX beam control information for control of the beam #j may perform activation of beam DRX for the beam #j. The terminal that has performed activation of beam DRX for the beam #j may perform a beam DRX operation for the beam #j according to a DRX beam service duration indicated by the UE DRX beam configuration information or UE DRX beam control information. The terminal may be in a wake-up state during an on-duration indicated by the UE DRX beam configuration information or UE DRX beam control information. The terminal in the wake-up state may perform downlink reception through the beam #j. The terminal may be in a sleep state or an energy saving state during an off-duration indicated by the UE DRX beam configuration information or UE DRX beam control information. The terminal in the sleep state may stop downlink reception through the beam #j.

In another example, the UE DRX beam control information for control of the beam #j may indicate activation of beam DRX for the beam #j. The terminal that has received the UE DRX beam control information for control of the beam #j may not be located in the beam service area #j covered by the beam #j. The terminal may not be able to perform activation of beam DRX for the beam #j according to the indication of the received UE DRX beam control information. However, the terminal may maintain the indication of the received UE DRX beam control information. The terminal that has maintained the indication of the received UE DRX beam control information may enter the beam service area #j. The terminal that has entered the beam service area #j may perform activation of beam DRX for the beam #j according to the maintained indication of the received UE DRX beam control information.

The UE DRX beam control information for control of the beam #j may include at least one of beam information corresponding to the beam #j, information indicating activation or deactivation of beam DRX for the beam #j, or information on a DRX beam service duration for a beam DRX operation for the beam #j.

A terminal may receive UE DRX beam configuration information including a DRX beam group temporary identifier. The DRX beam group temporary identifier may correspond to a beam group including a beam #a1 and a beam #a2. In other words, the DRX beam group temporary identifier may be a temporary identifier for a beam DRX operation for the beam #a1 and the beam #a2. The terminal may perform a monitoring operation for receiving a PDCCH including DCI including UE DRX beam control information for control of beam DRX for the beam #a1 and the beam #a2 through the DRX beam group temporary identifier in beam service areas covered by the beam #a1 and the beam #a2. The UE DRX beam control information may be transmitted through the beam #a1 and the beam #a2.

The UE DRX beam control information for control of beam DRX for the beam #a1 and the beam #a2 may indicate activation of beam DRX for the beam #a1 and the beam #a2. The terminal may be located in the beam service areas covered by the beam #a1 and the beam #a2. The terminal that has received the UE DRX beam control information for control of beam DRX for the beam #a1 and the beam #a2 may perform activation of beam DRX for the beam #a1 and the beam #a2. The terminal that has performed activation of beam DRX for the beam #a1 and the beam #a2 may perform a beam DRX operation for the beam #a1 and the beam #a2 according to a DRX beam service duration indicated by the UE DRX beam configuration information or UE DRX beam control information. The terminal may be in a wake-up state during an on-duration indicated by the UE DRX beam configuration information or UE DRX beam control information. The terminal in the wake-up state may perform downlink reception through the beam #a1 and the beam #a2. The terminal may be in a sleep state or an energy saving state during an off-duration indicated by the UE DRX beam configuration information or UE DRX beam control information. The terminal in the sleep state may stop downlink reception through the beam #a1 and the beam #a2.

The UE DRX beam control information for control of beam DRX for the beam #a1 and the beam #a2 may include at least one of beam information corresponding to the beam #a1 and the beam #a2, information indicating activation or deactivation of beam DRX for the beam #a1 and the beam #a2, or information on a DRX beam service duration for a beam DRX operation for the beam #a1 and the beam #a2.

Downlink signal(s) received by a terminal belonging to a terminal group from a base station through a beam may include at least one of a synchronization signal, a synchronization signal block, a reference signal, a PDCCH, or a PDSCH. The reference signal may be one of a reference signal for acquisition of CSI, a CSI-RS for beam management, a TRS for time tracking, or a PT-RS used for phase estimation of a PDSCH.

A terminal may decode a PDCCH including UE DRX beam control information including information indicating deactivation of beam DRX by using a temporary identifier included in UE DRX configuration information received by the terminal. When the terminal decodes the PDCCH, the terminal may perform deactivation of beam DRX according to an indication of the UE DRX beam control information. The terminal that has performed deactivation of beam DRX may stop beam DRX. The terminal that has stopped beam DRX may continuously perform a reception operation.

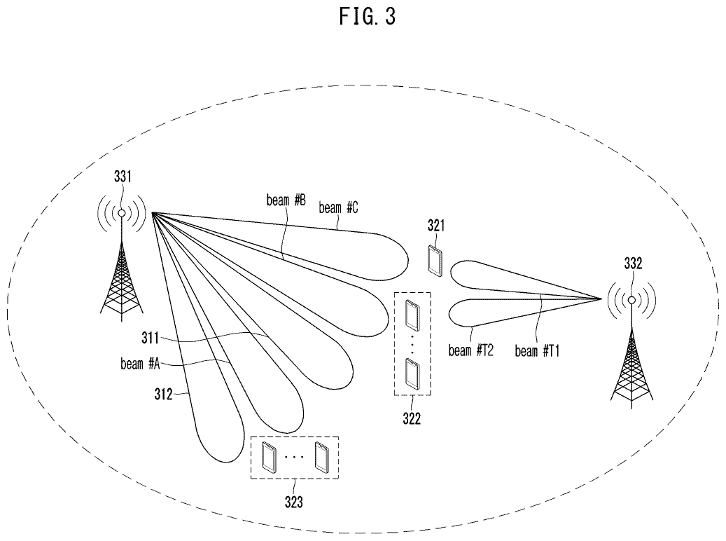

FIG. 3 is a conceptual diagram illustrating exemplary embodiments of terminal groups according to beam service areas.

A communication system may include a base station 331, a transmission point (TP) 332, terminal groups 322 and 323, and a terminal 321. The base station 331 and the TP 332 may form multiple beams. The base station 331 and the TP 332 may control beam DRX of the terminal groups 322 and 323 or the terminal 321. The base station 331 and the TP 332 may form multiple beams in a cell-common service area. The base station and the TP 331 and 332 may form beam group(s) each including a plurality of beams. The base station and the TP 331 and 332 may classify multiple beams into one or more beam groups in consideration of at least one of locations of antennas belonging to the base station or the TP 331 and 332, a number of antenna ports, directions of beams, beamwidth sizes, a number of terminals connected to the base station or the TP 331 and 332, traffic load of the terminals, load due to beamforming of the base station or the TP, CSI of the terminals, or measurement reports on beams.

The base station and the TP 331 and 332 may transmit UE DRX beam configuration information to the terminal 321 or the terminal groups 322 and 323. The UE DRX beam configuration information may be the same as the UE DRX beam configuration information described in the UE DRX beam configuration information described above. Beam DRX may be configured for a beam #A. In other words, the base station 331 may transmit UE DRX beam configuration information to the terminal group 323 through the beam #A. However, the terminal group 323 may be in a beam DRX deactivated state. Beam DRX may be configured for a beam #B. In other words, the base station may transmit UE DRX beam configuration information to the terminal group 322 through the beam #B. The terminal group 322 may activate beam DRX for the beam #B through UE DRX beam control information received through the beam #B. Beam DRX may not be configured for a beam #C. In other words, UE DRX beam configuration information may not be transmitted through the beam #C. However, the terminal 321 located in a beam service area covered by the beam #C may belong to a beam service area covered by a beam #T1. Beam DRX may be configured for the beam #T1. However, the terminal 321 may be in a beam DRX deactivated state.

Beam DRX may not be configured for beams 311 and 312. In other words, the base station may not transmit UE DRX beam configuration information through the beams 311 and 312.

Referring to Table 1, an example of UE DRX beam configuration information may be provided. The UE DRX beam configuration information identified in Table 1 may be an example of UE DRX beam configuration information described in the UE DRX beam configuration information described above. Referring to Table 2, a DRX service duration set including DRX service durations as elements may be provided. Each of the DRX service durations identified in Table 2 may be the same as information on the DRX service duration described in the UE DRX beam configuration information section described above.

TABLE 1
UE DRX beam configuration information

DRX beam information #1: Beam information #1, DrxBeamUeGroup-
RNTI #1, DRX beam service duration #1
DRX beam information #2: Beam information #2, DrxBeamUeGroup-
RNTI #2, DRX beam service duration #2
. . .
DRX beam information #j: Beam information #j, DrxBeamUeGroup-
RNTI #j, DRX beam service duration #j
DRX beam group information #a: Beam information #a1,
Beam information #a2, DrxBeamGroup-RNTI #a,
DRX beam service duration #a
DRX beam group information #b: Beam information #b1,
Beam information #b2, DrxBeamGroup-RNTI #b,
DRX beam service duration #b
Cell-common DRX beam information: Beam information #1, . . . ,
Beam information #i, CellCommonDrxBeam-RNTI,
cell-common DRX beam service duration

TABLE 2
DRX service duration set

DRX service duration #1: on-duration #1, off-duration #1,
DRX cycle #1, DRX offset #1
DRX service duration #2: on-duration #2, off-duration #2,
DRX cycle #2, DRX offset #2
. . .
DRX service duration #k: on-duration #k, off-duration #k,
DRX cycle #k, DRX offset #k
DRX service duration #a: on-duration #a, off-duration #a,
DRX cycle #a, DRX offset #a
DRX service duration #b: on-duration #b, off-duration #b,
DRX cycle #b, DRX offset #b

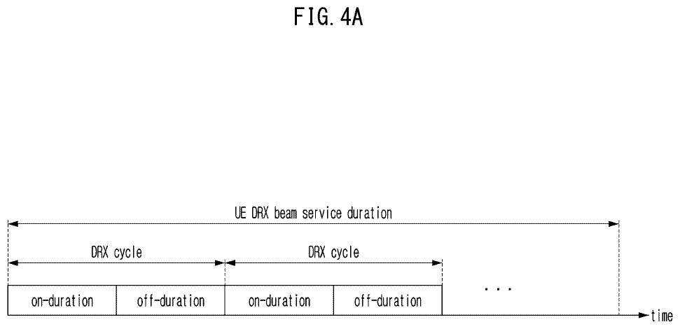

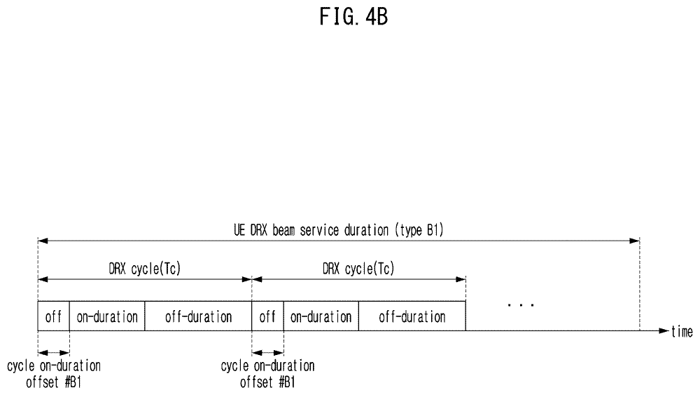

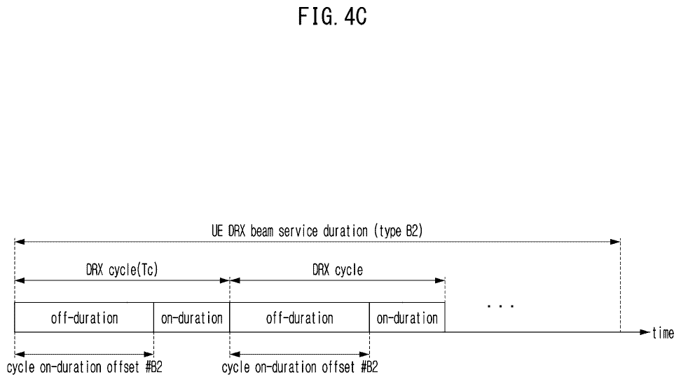

FIG. 4A is a timing diagram illustrating exemplary embodiments of a DRX beam service duration.

Referring to FIG. 4A, a DRX beam service duration may include a plurality of DRX cycles. Each of the plurality of DRX cycles may include an on-duration and an off-duration. The DRX beam service duration may not include a DRX offset.

FIG. 4B is a timing diagram illustrating exemplary embodiments of a DRX beam service duration.

Referring to FIG. 4B, a DRX beam service duration may include a plurality of DRX cycles. Each of the plurality of DRX cycles may include an on-duration and an off-duration. Each of the plurality of cycles may include an on-duration whose start time is changed by a DRX offset (e.g. a cycle on-duration offset #B1). The cycle on-duration offset #B1 may be located near a start time of a DRX cycle.

FIG. 4C is a timing diagram illustrating exemplary embodiments of a DRX beam service duration.

Referring to FIG. 4C, a DRX beam service duration may include a plurality of DRX cycles. Each of the plurality of DRX cycles may include an on-duration and an off-duration. Each of the plurality of cycles may include an on-duration whose start time is changed by a DRX offset (e.g. a cycle on-duration offset #B2). The cycle on-duration offset #B2 may be located near a start time of a DRX cycle. The cycle on-duration offset #B2 may be set to be equal to a length of the off-duration. When the length of the cycle on-duration offset #B2 is set to be equal to the length of the off-duration, the on-duration may be located after the off-duration.

Referring to Table 3, an example of UE DRX beam control information received by a terminal that has received UE DRX beam configuration information according to Table 1 and Table 2 may be provided. The UE DRX beam control information identified in Table 3 may be the same as that of the UE DRX beam control information section described above.

TABLE 3

| | |
|---|---|
| Activation/deactivation | Serving cell ID |

Number of beams for which beam DRX is activated or deactivated: 1~j
DRX beam: beam information #1~beam information #j
DRX beam group information
DRX beam service duration

Referring to Table 4, an example of UE DRX beam configuration information may be provided. The UE DRX beam configuration information identified in Table 4 may be an example of the UE DRX beam configuration information described in the UE DRX beam configuration information described above. Referring to Table 5, a DRX service duration set including DRX service durations as elements may be provided. Each of the DRX service durations identified in Table 5 may be the same as the information on a DRX service duration described in the UE DRX beam configuration information section described above.

TABLE 4
UE DRX beam configuration information

DRX beam information #A: Beam information #A, DrxBeamUeGroup-
RNTI #A, DRX beam service duration #A
DRX beam information #B: Beam information #B, DrxBeamUeGroup-
RNTI #B, DRX beam service duration #B
. . .
DRX beam information #T1: Beam information #T1, DrxBeamUeGroup-
RNTI #T1, DRX beam service duration #T1
DRX beam information #T2: Beam information #T2, DrxBeamUeGroup-
RNTI #T2, DRX beam service duration #T2
DRX beam group information #a: Beam information #B,
beam information #T1, DrxBeamGroup-RNTI #a,
DRX beam service duration #a
Cell-common DRX beam information: Beam information #A,
Beam information #B, Beam information #T1,
Beam information #T2, CellCommonDrxBeam-RNTI,
cell-common DRX beam service duration

TABLE 5
Information on DRX service durations

DRX service duration #A: on-duration #A, off-duration #A,
DRX cycle #A, DRX offset #A
DRX service duration #B: on-duration #B, off-duration #B,
DRX cycle #B, DRX offset #B
DRX service duration #T1: on-duration #T1, off-duration #T1,
DRX cycle #T1, DRX offset #T1
DRX service duration #T2: on-duration #T2, off-duration #T2,
DRX cycle #T2, DRX offset #T2
DRX service duration #a: on-duration #a, off-duration #a,
DRX cycle #a, DRX offset #a

Referring to Table 6, an example of UE DRX beam control information received by a terminal that has received the UE DRX beam configuration information according to Table 4 and Table 5 may be provided. The UE DRX beam control information identified in Table 6 may be the same as that of the UE DRX beam control information section described above.

TABLE 6

| | |
|---|---|
| Activation/deactivation | Service cell ID |

Number of beams for which beam DRX is activated or deactivated: 1 or 2
DRX beams: Beam information #B and/or Beam information #T1
Cell-common DRX beam service duration

Referring to Table 7, an example of UE DRX beam control information received by a terminal that has received the UE DRX beam configuration information according to Table 4 and Table 5 may be provided. The UE DRX beam control information identified in Table 7 may be the same as that of the UE DRX beam control information section described above.

TABLE 7

| | |
|---|---|
| Activation/deactivation | Service cell ID |

Number of beams for which beam DRX is activated or deactivated: 1
DRX beam group information #a

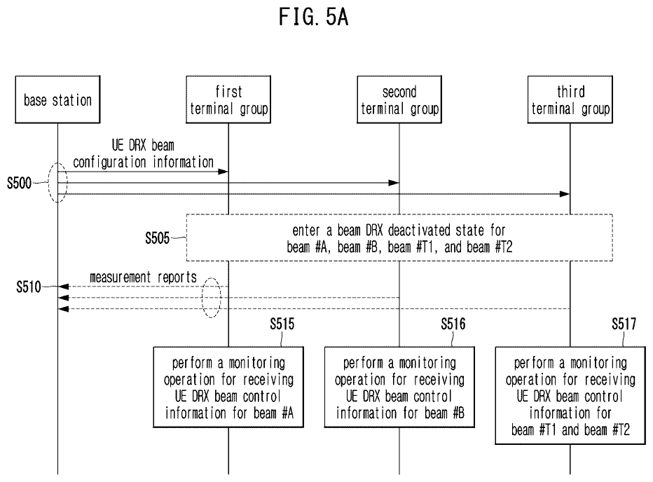

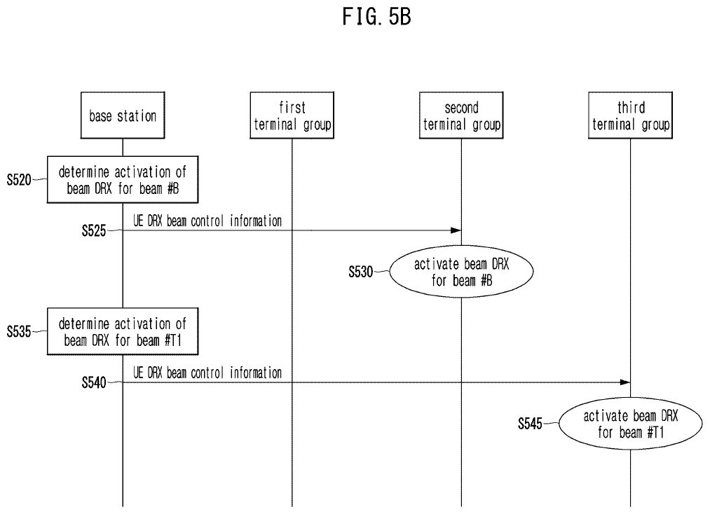

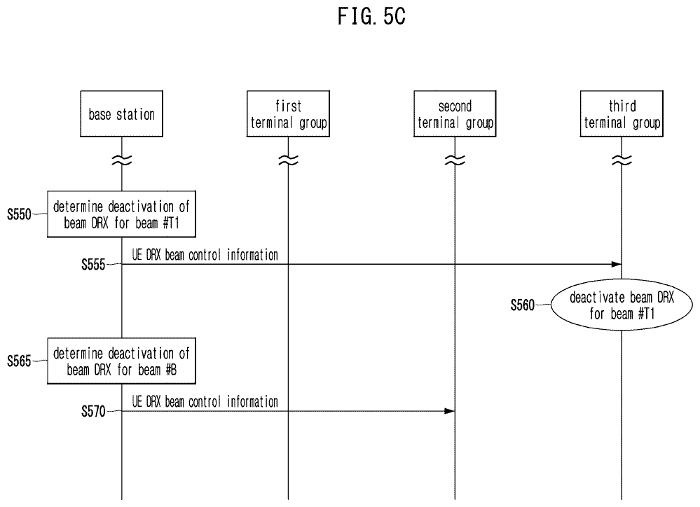

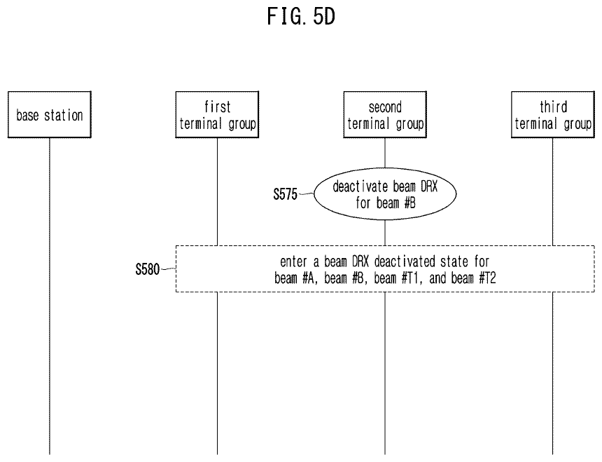

FIG. 5A to FIG. 5D are sequence diagrams illustrating exemplary embodiments of a UE DRX operation control procedure.

UE DRX beam configuration information and UE DRX beam control information according to the exemplary embodiments illustrated in FIG. 5A to FIG. 5D may be the same as the UE DRX beam configuration information and the UE DRX beam control information described in the UE DRX beam configuration information section and the UE DRX beam control information section described above. Operations of a base station and operations of a terminal group or a terminal according to the exemplary embodiments illustrated in FIG. 5A to FIG. 5D may be the same as operations of the base station and operations of the terminal described in the ‘operations of a base station for beam DRX control’ section described above and the ‘operations of a terminal for beam DRX control’ section described above.

Referring to FIG. 5A, a base station may form multiple beams. A first terminal group, a second terminal group, and a third terminal group may belong to beam service areas formed by the multiple beams. The first terminal group may include a terminal #A1 to a terminal #Am. The first terminal group may include m terminals. The first terminal group may belong to a beam service area #A formed by a beam #A. The second terminal group may belong to a beam service area #B formed by a beam #B. The second terminal group may include a terminal #B1 to a terminal #Bn. The second terminal group may include n terminals. The third terminal group may belong to a beam service area #C formed by a beam #T1 and a beam #T2. The third terminal group may include a terminal #C1 to a terminal #Ck. The third terminal group may include k terminals. The situation according to the exemplary embodiments illustrated in FIG. 5A to FIG. 5D may be the same as the situation according to the exemplary embodiments illustrated in FIG. 3.

The base station may transmit UE DRX beam configuration information to the first terminal group, the second terminal group, and the third terminal group (S500). The transmitted UE DRX beam configuration information may include a DRX beam terminal group temporary identifier. The first terminal group may receive a DRX beam terminal group temporary identifier #A. The second terminal group may receive a DRX beam terminal group temporary identifier #B. The third terminal group may receive a DRX beam terminal group temporary identifier #T1 and a DRX beam terminal group temporary identifier #T2.

The terminal groups that have received the UE DRX beam configuration information may enter a beam DRX deactivated state (S505). In other words, the terminal groups may enter a ready state in which the terminal groups can activate beam DRX. The first terminal group may transmit a measurement report or a beam report for the beam #A to the base station (S510). The second terminal group may transmit a measurement report or a beam report for the beam #B to the base station (S510). The third terminal group may transmit a measurement report or a beam report for the beam #T1 and the beam #T2 to the base station (S510).

The first terminal group that has received the UE DRX beam configuration information may perform a monitoring operation for receiving a PDCCH including UE DRX beam control information for controlling beam DRX for the beam #A by using the DRX beam terminal group temporary identifier #A (S515). The second terminal group that has received the UE DRX beam configuration information may perform a monitoring operation for receiving a PDCCH including UE DRX beam control information for controlling beam DRX for the beam #B by using the DRX beam terminal group temporary identifier #B (S516). The third terminal group that has received the UE DRX beam configuration information may perform a monitoring operation for receiving a PDCCH including UE DRX beam control information for controlling beam DRX for the beam #T1 by using the DRX beam terminal group temporary identifier #T1 (S517). The third terminal group that has received the UE DRX beam configuration information may perform a monitoring operation for receiving a PDCCH including UE DRX beam control information for controlling beam DRX for the beam #T2 by using the DRX beam terminal group temporary identifier #T2 (S517). The order of the monitoring operations of the first terminal group, the second terminal group, and the third terminal group may be changed.

Referring to FIG. 5B, the base station may determine whether to activate beam DRX for the beam #B (S520). The base station that has determined activation of beam DRX for the beam #B may generate UE DRX beam control information. The UE DRX beam control information may include information indicating activation of beam DRX for the beam #B. The base station may transmit, to the second terminal group in a groupcasting scheme, a PDCCH including the UE DRX beam control information for control of beam DRX for the beam #B (S525). A CRC of DCI included in the PDCCH may be scrambled with the DRX beam terminal group temporary identifier #B. Since the second terminal group performs a monitoring operation with the DRX beam terminal group temporary identifier #B, the second terminal group may receive the UE DRX beam control information for control of beam DRX for the beam #B. The second terminal group that has received the UE DRX beam control information for control of beam DRX for the beam #B may perform activation of beam DRX for the beam #B (S530).

The base station may determine whether to activate beam DRX for the beam #T1 (S535). The base station that has determined activation of beam DRX for the beam #T1 may generate UE DRX beam control information. The UE DRX beam control information may include information indicating activation of beam DRX for the beam #T1. The base station may transmit, to the third terminal group in a groupcasting scheme, a PDCCH including the UE DRX beam control information for control of beam DRX for the beam #T1 (S540). A CRC of DCI included in the PDCCH may be scrambled with the DRX beam terminal group temporary identifier #T1. Since the third terminal group performs a monitoring operation with the DRX beam terminal group temporary identifier #T1, the third terminal group may receive the UE DRX beam control information for control of beam DRX for the beam #T1. The third terminal group that has received the UE DRX beam control information for control of beam DRX for the beam #T1 may perform activation of beam DRX for the beam #T1 (S545).

Referring to FIG. 5C, the base station may determine whether to deactivate beam DRX for the beam #T1 (S550). The base station that has determined deactivation of beam DRX for the beam #T1 may generate UE DRX beam control information. The UE DRX beam control information may include information indicating deactivation of beam DRX for the beam #T1. The base station may transmit, to the third terminal group in a groupcasting scheme, a PDCCH including the UE DRX beam control information for control of beam DRX for the beam #T1 (S555). A CRC of DCI included in the PDCCH may be scrambled with the DRX beam terminal group temporary identifier #T1. Since the third terminal group performs a monitoring operation with the DRX beam terminal group temporary identifier #T1, the third terminal group may receive the UE DRX beam control information for control of beam DRX for the beam #T1. The third terminal group that has received the UE DRX beam control information for control of beam DRX for the beam #T1 may perform deactivation of beam DRX for the beam #T1 (S560).

Referring to FIG. 5C, the base station may determine whether to deactivate beam DRX for the beam #B (S565). The base station that has determined deactivation of beam DRX for the beam #B may generate UE DRX beam control information. The UE DRX beam control information may include information indicating deactivation of beam DRX for the beam #B. The base station may transmit, to the second terminal group in a groupcasting scheme, a PDCCH including the UE DRX beam control information for control of beam DRX for the beam #B (S570). Since the second terminal group performs a monitoring operation with the DRX beam terminal group temporary identifier #B, the second terminal group may receive the UE DRX beam control information for control of beam DRX for the beam #B.

Referring to FIG. 5D, the second terminal group that has received the UE DRX beam control information for control of beam DRX for the beam #B may perform deactivation of beam DRX for the beam #B (S575). The terminal groups that have performed deactivation of beam DRX may enter a beam DRX deactivated state (S580).

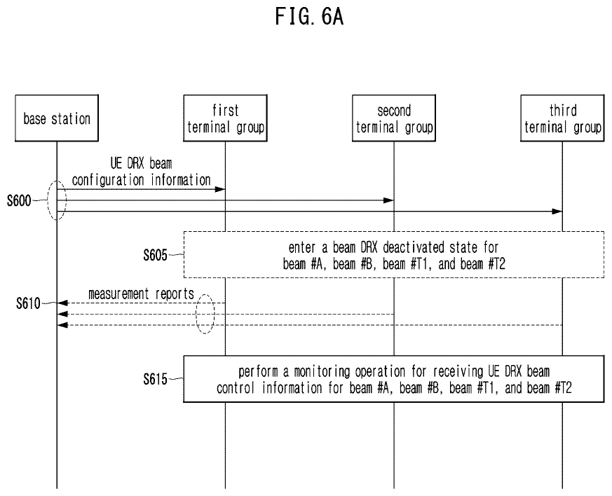

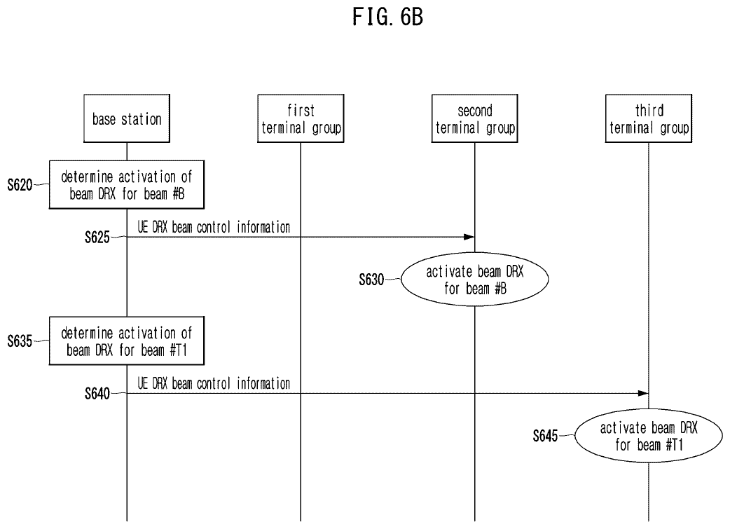

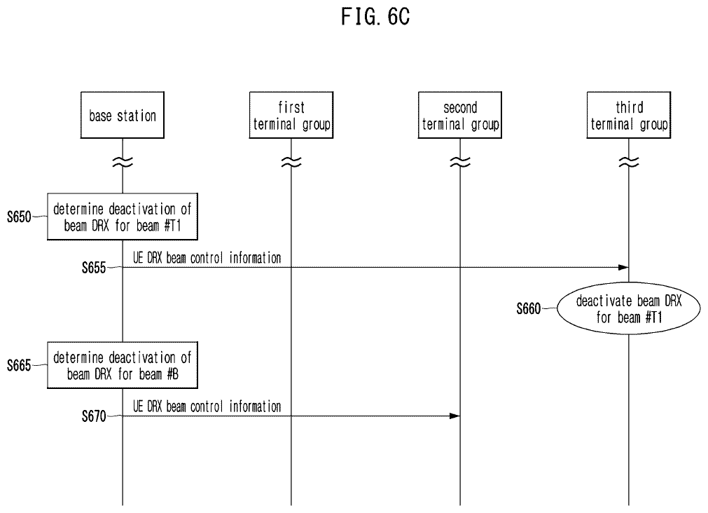

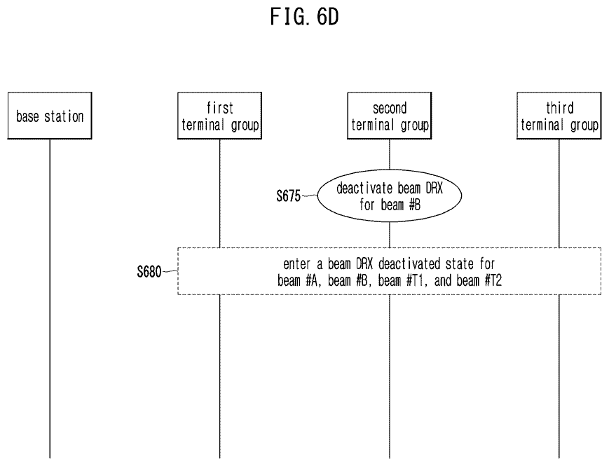

FIG. 6A to FIG. 6D are sequence diagrams illustrating exemplary embodiments of a UE DRX operation control procedure.

UE DRX beam configuration information and UE DRX beam control information according to the exemplary embodiments illustrated in FIG. 6A to FIG. 6D may be the same as the UE DRX beam configuration information and UE DRX beam control information described in the UE DRX beam configuration information section and the UE DRX beam control information section described above. Operations of a base station and operations of a terminal group (or a terminal) according to the exemplary embodiments illustrated in FIG. 6A to FIG. 6D may be the same as operations of the base station and operations of the terminal described in the ‘operations of a base station for beam DRX control’ section described above and the ‘operations of a terminal for beam DRX control’ section described above.

Referring to FIG. 6A, a base station may form multiple beams. A first terminal group, a second terminal group, and a third terminal group may belong to beam service areas formed by the multiple beams. The first terminal group may include a terminal #A1 to a terminal #Am. The first terminal group may include m terminals. The first terminal group may belong to a beam service area #A formed by a beam #A. The second terminal group may belong to a beam service area #B formed by a beam #B. The second terminal group may include a terminal #B1 to a terminal #Bn. The second terminal group may include n terminals. The third terminal group may belong to a beam service area #C formed by a beam #T1 and a beam #T2. The third terminal group may include a terminal #C1 to a terminal #Ck. The third terminal group may include k terminals. The situation according to the exemplary embodiments illustrated in FIG. 6A to FIG. 6D may be the same as the situation according to the exemplary embodiments illustrated in FIG. 3.

The base station may transmit UE DRX beam configuration information to the first terminal group, the second terminal group, and the third terminal group (S600). The transmitted UE DRX beam configuration information may include a cell-common DRX beam temporary identifier. The first terminal group, the second terminal group, and the third terminal group may receive the cell-common DRX beam temporary identifier.

The terminal groups that have received the UE DRX beam configuration information may enter a beam DRX deactivated state (S605). In other words, the terminal groups may enter a ready state in which beam DRX can be activated. The first terminal group may transmit a measurement report or a beam report for the beam #A to the base station (S610). The second terminal group may transmit a measurement report or a beam report for the beam #B to the base station (S610). The third terminal group may transmit a measurement report or a beam report for the beam #T1 and the beam #T2 to the base station (S610).

The first terminal group that has received the UE DRX beam configuration information may perform a monitoring operation for receiving a PDCCH including UE DRX beam control information for controlling beam DRX for the beam #A by using the cell-common DRX beam temporary identifier (S615). The second terminal group that has received the UE DRX beam configuration information may perform a monitoring operation for receiving a PDCCH including UE DRX beam control information for controlling beam DRX for the beam #B by using the cell-common DRX beam temporary identifier (S615). The third terminal group that has received the UE DRX beam configuration information may perform a monitoring operation for receiving a PDCCH including UE DRX beam control information for controlling beam DRX for the beam #T1 by using the cell-common DRX beam temporary identifier (S615). The third terminal group that has received the UE DRX beam configuration information may perform a monitoring operation for receiving a PDCCH including UE DRX beam control information for controlling beam DRX for the beam #T2 by using the cell-common DRX beam temporary identifier. The order of the monitoring operations of the first terminal group, the second terminal group, and the third terminal group may be changed.

Referring to FIG. 6B, the base station may determine whether to activate beam DRX for the beam #B (S620). The base station that has determined activation of beam DRX for the beam #B may generate UE DRX beam control information. The UE DRX beam control information may include information indicating activation of beam DRX for the beam #B. The base station may transmit, to the second terminal group in a groupcasting scheme, a PDCCH including the UE DRX beam control information for control of beam DRX for the beam #B (S625). A CRC of DCI included in the PDCCH may be scrambled with the cell-common DRX beam temporary identifier. Since the second terminal group performs a monitoring operation with the cell-common DRX beam temporary identifier, the second terminal group may receive the UE DRX beam control information for control of beam DRX for the beam #B. The second terminal group that has received the UE DRX beam control information for control of beam DRX for the beam #B may perform activation of beam DRX for the beam #B (S630).

The base station may determine whether to activate beam DRX for the beam #T1 (S635). The base station that has determined activation of beam DRX for the beam #T1 may generate UE DRX beam control information. The UE DRX beam control information may include information indicating activation of beam DRX for the beam #T1. The base station may transmit, to the third terminal group in a groupcasting scheme, a PDCCH including the UE DRX beam control information for control of beam DRX for the beam #T1 (S640). A CRC of DCI included in the PDCCH may be scrambled with the cell-common DRX beam temporary identifier. Since the third terminal group performs a monitoring operation with the cell-common DRX beam temporary identifier, the third terminal group may receive the UE DRX beam control information for control of beam DRX for the beam #T1. The third terminal group that has received the UE DRX beam control information for control of beam DRX for the beam #T1 may perform activation of beam DRX for the beam #T1 (S645).

In another example, the base station may determine activation of beam DRX for the beam #B and the beam #T1. The base station may transmit, to the second terminal group and the third terminal group in a groupcasting scheme, UE DRX beam control information including information indicating activation of beam DRX for the beam #B and the beam #T1. In other words, the UE DRX beam control information received by the second terminal group and the third terminal group may be the same.

Referring to FIG. 6C, the base station may determine whether to deactivate beam DRX for the beam #T1 (S650). The base station that has determined deactivation of beam DRX for the beam #T1 may generate UE DRX beam control information. The UE DRX beam control information may include information indicating deactivation of beam DRX for the beam #T1. The base station may transmit, to the third terminal group in a groupcasting scheme, a PDCCH including the UE DRX beam control information for control of beam DRX for the beam #T1 (S655). A CRC of DCI included in the PDCCH may be scrambled with the cell-common DRX beam temporary identifier. Since the third terminal group performs a monitoring operation with the cell-common DRX beam temporary identifier, the third terminal group may receive the UE DRX beam control information for control of beam DRX for the beam #T1. The third terminal group that has received the UE DRX beam control information for control of beam DRX for the beam #T1 may perform deactivation of beam DRX for the beam #T1 (S660).

The base station may determine whether to deactivate beam DRX for the beam #B (S665). The base station that has determined deactivation of beam DRX for the beam #B may generate UE DRX beam control information. The UE DRX beam control information may include information indicating deactivation of beam DRX for the beam #B. The base station may transmit, to the second terminal group in a groupcasting scheme, a PDCCH including the UE DRX beam control information for control of beam DRX for the beam #B (S670). A CRC of DCI included in the PDCCH may be scrambled with the cell-common DRX beam temporary identifier. Since the second terminal group performs a monitoring operation with the cell-common DRX beam temporary identifier, the second terminal group may receive the UE DRX beam control information for control of beam DRX for the beam #B.

Referring to FIG. 6D, the second terminal group that has received the UE DRX beam control information for control of beam DRX for the beam #B may perform deactivation of beam DRX for the beam #B (S675). In another example, the base station may determine deactivation of beam DRX for the beam #B and the beam #T1. The base station may transmit, to the second terminal group and the third terminal group in a groupcasting scheme, UE DRX beam control information including information indicating deactivation of beam DRX for the beam #B and the beam #T1. In other words, the UE DRX beam control information received by the second terminal group and the third terminal group may be the same. The terminal groups that have performed deactivation of beam DRX may enter a beam DRX deactivated state (S680).

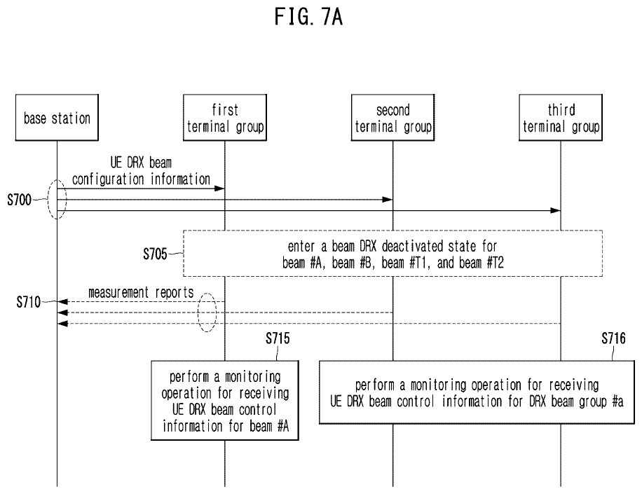

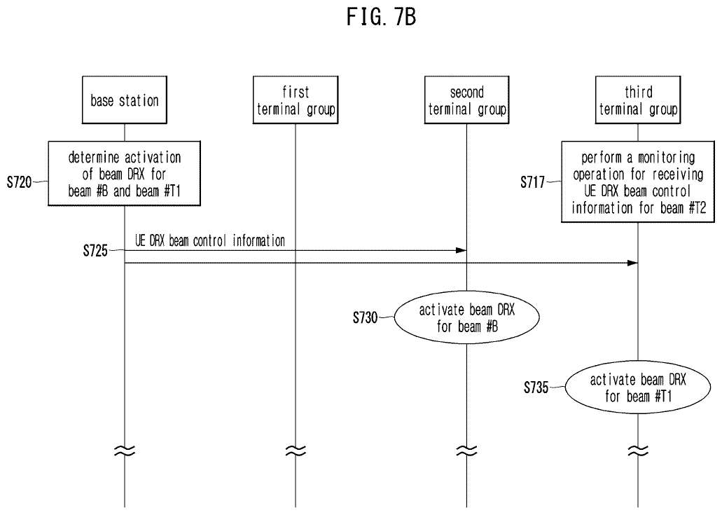

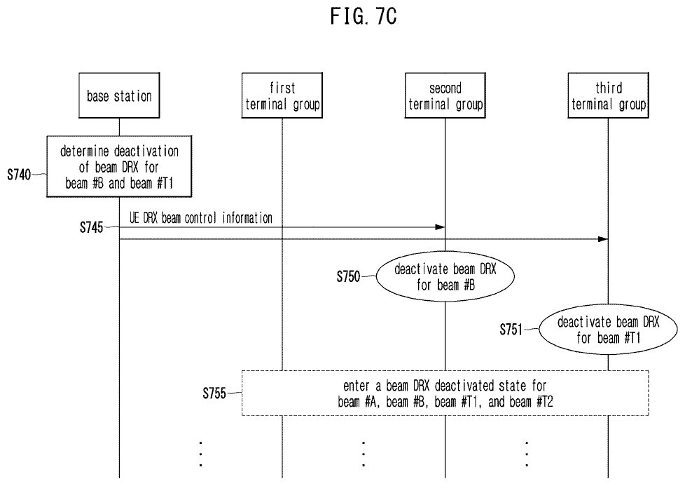

FIG. 7A to FIG. 7C are sequence diagrams illustrating exemplary embodiments of a UE DRX operation control procedure.

UE DRX beam configuration information and UE DRX beam control information according to the exemplary embodiments illustrated in FIG. 7A to FIG. 7C may be the same as the UE DRX beam configuration information and UE DRX beam control information described in the UE DRX beam configuration information section and the UE DRX beam control information section described above. Operations of a base station and operations of a terminal group (or a terminal) according to the exemplary embodiments illustrated in FIG. 7A to FIG. 7C may be the same as operations of the base station and operations of the terminal described in the ‘operations of a base station for beam DRX control’ section described above and the ‘operations of a terminal for beam DRX control’ section described above.

Referring to FIG. 7A, a base station may form multiple beams. A first terminal group, a second terminal group, and a third terminal group may belong to beam service areas formed by the multiple beams. The first terminal group may include a terminal #A1 to a terminal #Am. The first terminal group may include m terminals. The first terminal group may belong to a beam service area #A formed by a beam #A. The second terminal group may belong to a beam service area #B formed by a beam #B. The second terminal group may include a terminal #B1 to a terminal #Bn. The second terminal group may include n terminals. The third terminal group may belong to a beam service area #C formed by a beam #T1 and a beam #T2. The third terminal group may include a terminal #C1 to a terminal #Ck. The third terminal group may include k terminals. The situation according to the exemplary embodiments illustrated in FIG. 7A to FIG. 7C may be the same as the situation according to the exemplary embodiments illustrated in FIG. 3.

The base station may transmit UE DRX beam configuration information to the first terminal group, the second terminal group, and the third terminal group (S700). The transmitted UE DRX beam configuration information may include DRX beam group information. The DRX beam group information may indicate a beam group #a including the beam #B and the beam #T1. The transmitted UE DRX beam configuration information may include a DRX beam terminal group temporary identifier #A, a DRX beam terminal group temporary identifier #T2, and a DRX beam group temporary identifier #a. The DRX beam group temporary identifier #a may correspond to a beam group #a. The first terminal group may receive the DRX beam terminal group temporary identifier #A. The second terminal group and the third terminal group may receive the DRX beam group temporary identifier #a. The third terminal group may receive the DRX beam terminal group temporary identifier #T2.

The terminal groups that have received the UE DRX beam configuration information may enter a beam DRX deactivated state (S705). In other words, the terminal groups may enter a ready state in which beam DRX can be activated. The first terminal group may transmit a measurement report or a beam report for the beam #A to the base station (S710). The second terminal group may transmit a measurement report or a beam report for the beam #B to the base station (S710). The third terminal group may transmit a measurement report or a beam report for the beam #T1 and the beam #T2 to the base station (S710).

The first terminal group that has received the UE DRX beam configuration information may perform a monitoring operation for receiving a PDCCH including UE DRX beam control information for controlling beam DRX for the beam #A by using the DRX beam terminal group temporary identifier #A (S715). The second terminal group that has received the UE DRX beam configuration information may perform a monitoring operation for receiving a PDCCH including UE DRX beam control information for controlling beam DRX for the beam #B by using the DRX beam group temporary identifier #a (S716). The third terminal group that has received the UE DRX beam configuration information may perform a monitoring operation for receiving a PDCCH including UE DRX beam control information for controlling beam DRX for the beam #T1 by using the DRX beam group temporary identifier #a (S716). The third terminal group that has received the UE DRX beam configuration information may perform a monitoring operation for receiving a PDCCH including UE DRX beam control information for controlling beam DRX for the beam #T2 by using the DRX beam terminal group temporary identifier #T2 (S717). The order of the monitoring operations of the first terminal group, the second terminal group, and the third terminal group may be changed.

Referring to FIG. 7B, the base station may determine whether to activate beam DRX for the beam group #a including the beam #B and the beam #T1 (S720). The base station that has determined activation of beam DRX for the beam group #a may generate UE DRX beam control information. The UE DRX beam control information may include information indicating activation of beam DRX for the beam group #a. The base station may transmit, to the second terminal group and the third terminal group in a groupcasting scheme, a PDCCH including the UE DRX beam control information for control of beam DRX for the beam group #a (S725). A CRC of DCI included in the PDCCH may be scrambled with the DRX beam group temporary identifier #a. Since the second terminal group performs a monitoring operation with the DRX beam group temporary identifier #a, the second terminal group may receive the UE DRX beam control information for control of beam DRX for the beam group #a. The second terminal group that has received the UE DRX beam control information for control of beam DRX for the beam group #a may perform activation of beam DRX for the beam #B (S730). Since the third terminal group performs a monitoring operation with the DRX beam group temporary identifier #a, the third terminal group may receive the UE DRX beam control information for control of beam DRX for the beam group #a. The third terminal group that has received the UE DRX beam control information for control of beam DRX for the beam group #a may perform activation of beam DRX for the beam #T1 (S735).

Referring to FIG. 7C, the base station may determine whether to deactivate beam DRX for the beam group #a including the beam #B and the beam #T1 (S740). The base station that has determined deactivation of beam DRX for the beam group #a may generate UE DRX beam control information. The UE DRX beam control information may include information indicating deactivation of beam DRX for the beam group #a. The base station may transmit, to the second terminal group and the third terminal group in a groupcasting scheme, a PDCCH including the UE DRX beam control information for control of beam DRX for the beam group #a (S745). A CRC of DCI included in the PDCCH may be scrambled with the DRX beam group temporary identifier #a. Since the second terminal group performs a monitoring operation with the DRX beam group temporary identifier #a, the second terminal group may receive the UE DRX beam control information for control of beam DRX for the beam group #a. The second terminal group that has received the UE DRX beam control information for control of beam DRX for the beam group #a may perform deactivation of beam DRX for the beam #B (S750). Since the third terminal group performs a monitoring operation with the DRX beam group temporary identifier #a, the third terminal group may receive the UE DRX beam control information for control of beam DRX for the beam group #a. The third terminal group that has received the UE DRX beam control information for control of beam DRX for the beam group #a may perform deactivation of beam DRX for the beam #T1 (S751).

The terminal groups that have performed deactivation of beam DRX may enter a beam DRX deactivated state (S755).

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a terminal, comprising:
receiving, from a base station, user equipment (UE) discontinuous reception (DRX) beam configuration information through one or more first beams covering a first beam service area in which a terminal group to which the terminal belongs is located;
transmitting, to the base station, a beam report for the one or more first beams; and
receiving, from the base station, UE DRX beam control information based on the UE DRX beam configuration information.

2. The method of claim 1, further comprising: performing a beam DRX operation for the one or more first beams based on the UE DRX beam configuration information,
wherein the beam DRX operation is performed by activation or deactivation of beam DRX for the one or more first beams based on the UE DRX beam control information.

3. The method of claim 1, further comprising: performing a beam DRX operation for one or more second beams based on the UE DRX beam configuration information, based on the UE DRX beam control information being received through the one or more second beams covering a second beam service area adjacent to the first beam service area.

4. The method of claim 1, wherein the UE DRX beam configuration information includes at least one of: DRX beam information for configuring beam DRX of a terminal group belonging to a specific beam service area covered by a beam formed by the base station; DRX beam group information for configuring beam DRX of a terminal group belonging to a beam group service area covered by a beam group including a plurality of beams formed by the base station; or cell-common DRX beam information for configuring beam DRX of a terminal group belonging to a cell-common service area covered by a cell formed by the base station.

5. The method of claim 4,
wherein the DRX beam information includes at least one of: beam information associated with the beam, a DRX beam terminal group temporary identifier corresponding to the beam, or information on a DRX beam service duration for a beam DRX operation associated with the beam,
wherein the beam information includes at least one of identification information of the beam, information of a reference signal transmitted through the beam, or a transmission configuration indicator (TCI) state associated with the reference signal, and
wherein based on the DRX beam information including the information on the DRX beam service duration, the information on the DRX beam service duration includes at least one of an on-duration, an off-duration, a DRX cycle, or a DRX start offset.

6. The method of claim 4,
wherein the DRX beam group information includes at least one of: beam information associated with each of the plurality of beams, a DRX beam group temporary identifier corresponding to the beam group, or information on a DRX beam service duration for a beam DRX operation associated with the beam group,
wherein the beam information includes at least one of identification information of each of the plurality of beams, information of reference signals transmitted through the plurality of beams, or TCI states associated with the reference signals, and
wherein based on the DRX beam group information including the information on the DRX beam service duration, the information on the DRX beam service duration includes at least one of an on-duration, an off-duration, a DRX cycle, or a DRX start offset.

7. The method of claim 4,
wherein the cell-common DRX beam information includes at least one of: beam information associated with each of beams belonging to the cell; a cell-common DRX beam temporary identifier corresponding to the cell; or information on a DRX beam service duration for a beam DRX operation associated with the beams,
wherein the beam information includes at least one of identification information of each of the beams, information of reference signals transmitted through the beams, or TCI states associated with the reference signals, and
wherein based on the cell-common DRX beam information including information on the DRX beam service duration, the information on the DRX beam service duration includes at least one of an on-duration, an off-duration, a DRX cycle, or a DRX start offset.

8. The method of claim 2, wherein the UE DRX beam control information includes at least one of beam information for each of the one or more first beams, information on a DRX beam service duration for the beam DRX operation, or information indicating activation or deactivation of beam DRX for the one or more first beams.

9. The method of claim 1, wherein the receiving of the UE DRX beam control information comprises:
performing a monitoring operation to receive a physical downlink control channel (PDCCH) including downlink control information (DCI) including the UE DRX beam control information, based on a temporary identifier included in the UE DRX beam configuration information; and
decoding the PDCCH to check a cyclic redundancy check (CRC) of the DCI scrambled with the temporary identifier, and receiving the UE DRX beam control information from the DCI.

10. The method of claim 1, wherein the receiving of the UE DRX beam control information comprises:
performing a monitoring operation to receive a PDCCH including DCI indicating a physical downlink shared channel (PDSCH) including the UE DRX beam control information, based on a temporary identifier included in the UE DRX beam configuration information;
decoding the PDCCH and performing decoding of the PDSCH based on a CRC of the DCI scrambled with the temporary identifier; and
receiving the UE DRX beam control information based on the decoding.

11. The method of claim 10, further comprising: stopping reception of one or more first signals transmitted through the one or more first beams during an off-duration indicated by the information on the DRX beam service duration, based on performing activation of the beam DRX,
wherein a type of the one or more first signals is one of a synchronization signal block, a synchronization signal, a PDCCH, a PDSCH, a channel state information reference signal (CSI-RS), a tracking reference signal (TRS), or a phase tracking reference signal (PT-RS).

12. A method of a base station, comprising:
transmitting, to a terminal, user equipment (UE) discontinuous reception (DRX) beam configuration information;
receiving, from the terminal, a beam report for one or more beams covering a beam service area in which a terminal group to which the terminal belongs is located;
determining, based on the beam report, whether to activate beam DRX of the terminal for the one or more beams; and
transmitting, to the terminal, UE DRX beam control information based on the determination.

13. The method of claim 12, wherein the beam report includes at least one of: channel state information (CSI) generated by the terminal or a measurement report for the one or more beams, and whether to activate beam DRX of the terminal is determined further based on at least one of a number of terminals belonging to the terminal group, a traffic load of the base station, or an energy state of a network to which the base station belongs.

14. The method of claim 12, wherein the UE DRX beam configuration information includes at least one of: DRX beam information for configuring beam DRX of a terminal group belonging to a specific beam service area covered by a beam formed by the base station; DRX beam group information for configuring beam DRX of a terminal group belonging to a beam group service area covered by each of a plurality of beams formed by the base station; or cell-common DRX beam information for configuring beam DRX of a terminal group belonging to a cell-common service area covered by a cell formed by the base station.

15. The method of claim 14,
wherein the DRX beam information includes at least one of: beam information associated with the beam; a DRX beam terminal group temporary identifier corresponding to the beam; or information on a DRX beam service duration for a beam DRX operation of a terminal associated with the beam,
wherein the beam information includes at least one of identification information of the beam, information of a reference signal transmitted through the beam, or a transmission configuration indicator (TCI) state associated with the reference signal, and
wherein based on the DRX beam information including the information on the DRX beam service duration, the information on the DRX beam service duration includes at least one of an on-duration, an off-duration, a DRX cycle, or a DRX start offset.

16. The method of claim 14,
wherein the DRX beam group information includes at least one of: beam information associated with each of the plurality of beams; a DRX beam group temporary identifier corresponding to the plurality of beams; or information on a DRX beam service duration for a DRX operation of a terminal associated with the plurality of beams,
wherein the beam information includes at least one of identification information of each of the plurality of beams, information of reference signals transmitted through the plurality of beams, or TCI states associated with the reference signals, and
wherein based on the DRX beam group information including the information on the DRX beam service duration, the information on the DRX beam service duration includes at least one of an on-duration, an off-duration, a DRX cycle, or a DRX start offset.

17. The method of claim 14,
wherein the cell-common DRX beam information includes at least one of: beam information associated with each of beams belonging to the cell; a cell-common DRX beam temporary identifier corresponding to the cell; or information on a DRX beam service duration for a beam DRX operation of a terminal associated with the beams,
wherein the beam information includes at least one of identification information of each of the beams, information of reference signals transmitted through the beams, or TCI states associated with the reference signals, and
wherein based on the cell-common DRX beam information including the information on the DRX beam service duration, the information on the DRX beam service duration includes at least one of an on-duration, an off-duration, a DRX cycle, or a DRX start offset.

18. The method of claim 14, wherein the UE DRX beam control information includes at least one of beam information for each of the one or more beams, information on a DRX beam service duration for a DRX operation by the terminal, or information indicating activation or deactivation of DRX for the one or more beams.

19. The method of claim 14, further comprising: performing suspension of downlink transmission to the terminal using the one or more beams during an off-duration indicated by the information on the DRX beam service duration,
wherein a signal subject to the suspension of the downlink transmission includes at least one of a synchronization signal block, a synchronization signal, a physical downlink control channel (PDCCH), a physical downlink shared channel (PDSCH), a channel state information reference signal (CSI-RS), a tracking reference signal (TRS), or a phase tracking reference signal (PT-RS).

20. The method of claim 12, wherein the UE DRX beam control information is transmitted through a PDCCH including downlink control information (DCI) having a cyclic redundancy check (CRC) scrambled based on a temporary identifier included in the UE DRX beam configuration information, or is transmitted through a PDSCH indicated by the DCI.
